(19) United States
(12) Patent Application Publication
(10) Pub. No.: US 2006/0154164 A1
(43) Pub. Date: Jul. 13, 2006

(54) Toner and process for producing the same

(76) Inventor: Hiroto Kidokoro, Tokyo (JP)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/528,834

(22) PCT Filed: Sep. 24, 2003
(86) PCT No.: PCT/JP03/12135

§ 371 Date: Oct. 21, 2005

(30) Foreign Application Priority Data
Sep. 25, 2002 (JP) 2002-279002
Sep. 25, 2002 (JP) 2002-279003
Sep. 25, 2002 (JP) 2002-279004

(51) Int. Cl. G03G 9/08; G03G 9/097

(52) U.S. Cl. 430/108.23; 430/111.4; 430/108.1; 430/108.21; 430/137.15; 430/109.2

(57) ABSTRACT

The toner of the present invention comprises at least a pigment and a binder resin, wherein a filtrate obtained by filtering a dispersion comprising 0.2 g of the toner dispersed in 100 ml of tetrahydrofuran through a filter with a pore size of 0.45 μm, when it is measured by a spectrophotometer, has: a maximum absorption between 380 nm and 440 nm wherein the absorbance at the maximum absorption is 1 or higher; a maximum absorption between 640 nm and 680 nm wherein the absorbance at the maximum absorption is 0.2 or higher; or a maximum absorption between 490 nm and 560 nm wherein the absorbance at the maximum absorption is 0.15 or higher. The toner of the present invention is excellent in dispersibility of the pigment and can provide good images.

### TECHNICAL FIELD

The present invention relates to a toner for developing an electrostatic latent image formed by an electrophotography method, an electrostatic recording method and the like, and in particular, to a toner excellent in dispersibility of the pigment.

### BACKGROUND ART

Electrophotography is a process in which an electrostatic latent image formed on a photoconductive member is developed with an electrostatic latent image developer including a toner a comprising colored particles and an external additive, and, if necessary, a charged toner image is transferred to a recording medium, such as paper or a printing matter, and then the transferred toner image is fixed to obtain a copy. Formation of a color image by a full-color electrophotography method comprises reproduction of all colors by using three colors of toners including a magenta, a cyan and a yellow toners, or preferably four colors of toners including a black toner in addition to the three colors of toners described above.

In a method for forming a full-color image by a full-color electrophotography method, for example a reflected light from an original document is subjected to color separation in an analog or a digital method, and then this information is introduced into a photoconductive layer of a photoconductive member to firstly form an electrostatic latent image of a first color. Then, the toner for the first color is transferred and put on a recording medium such as paper, after developing and transferring steps. The same operations are repeated for the second color and the other colors, thereby superimposing a plurality of toners on the same recording medium. The superimposed toners are fixed by various methods such as heating, pressurizing, solvent vapor or the like to obtain a final full-color image.

As described above, in the full-color image formed by the full-color electrophotography method, four or less colors of toners are superimposed on a recording medium. Accordingly, the amount of fixed toner per unit area on a recording medium, such as paper, is higher than that in the case of a single color of black, which may cause unfavorable effect on a resulting image. For example, after fixation, the recording medium may have warpage (cockle); the image may have a feeling of asperities; and the color may be poor in transparency, clearity and reproducibility.

In order to solve the above described problems, it is preferable to reduce the amount of each color toner used. However, the reduction of the amount of toner used may involve the reduction of color density. Increase of the proportion of pigment to be added relative to the weight of toner may be an idea to solve the problem of the reduction of color density, but it may have an effect on the basic characteristics of toner such as fixability and a charging property of toner. Therefore, this method may also be limited.

The smaller the particle diameter of pigments, the higher image density it provides, provided that the added amount of the pigment in toner is the same. This is considered because a color comes out as light of specific wavelength, among the light irradiated on particles of the pigment, which is absorbed with higher possibility, when the number of particles of the pigment or the surface area of the pigment existing in toner increases. However, if the particle diameter of pigment particles is too small, the color may not come out well, because light passes through the particles. Moreover, when pigment particles with a small particle diameter have aggregated, they behave in the similar manner to those with a large particle diameter. Therefore, pigment particles is required to be uniformly dispersed in toner.

A method for reducing the particle diameter of particles of a pigments in toner typically includes the methods for reducing the particle size using dispersion machines such as, for example, a sand mill, a three-roll mill, a ball mill and an extruder. Generally, pigments have secondary particles which are formed by a slight aggregation of primary particles. The above described methods are only effective to the extent that secondary particles are broken into primary particles, and the further finer particles of pigment is not easily obtained by the above described methods. Although it is possible to break pigment particles into further finer particles by using a high speed sand mill or the like, this method requires very high energy.

Other known methods of forming finer particles of pigment include a method in which pigment particles, a binder resin and the like are strongly kneaded while heated by using a two-roll mill, a Banbury mixer or the like. However, since pigments generally exhibit crystal growth at elevated temperatures, this method reaches an end point whenmechanical breaking strength and crystal growth reach equilibrium, limiting the reduction of the size of pigment particles.

Furthermore, as a method for reducing the particle diameter of pigment particles, there is a method for obtaining pigment particles with fine primary particles by wetting the mixture of a pigment and a water soluble inorganic salt such as common salt with a small amount of water soluble solvent, strongly kneading the wet mixture using a kneader or the like, washing the inorganic salt and the solvent with water to remove them and drying the resultant pigment. However, even by this method, pigment may undergo strong secondary agglomeration when it is dried, increasing the particle size of the pigment particles.

As described above, although it is difficult to reduce the particle diameter of pigment particles, it is further difficult to uniformly disperse pigments having a small particle diameter into a toner. This is because pigments tend to aggregate as the polymerization of a polymerizable monomer proceeds, particularly in a method for producing toner by a process in which a polymerizable monomer having a pigment dispersed therein is polymerized.

Japanese Patent Application Laid-Open No. 1997-160299 discloses a toner for developing an electrostatic image, mainly composed of a pigment treated with rosin with an epoxy group or a rosin-modified compound. Moreover, Japanese Patent Application Laid-Open No. 1995-43944 discloses an electrophotographic toner, comprising a styrene-acrylic copolymer resin comprising a carboxyl group, and an acrylic resin comprising a glycidyl group; and Japanese Patent Application Laid-Open No. 1994-11890 discloses an electrophotographic toner comprising a styrene-acrylic resin having a glycidyl group. Although the toners disclosed in the above documents have improved dispersibility of pigments, these toners do not have a spherical shape and have a surface with asperities formed thereon, resulting in deterioration of transfering properties and resolution. In addition, there also exists a problem that, since a solid raw toner material is brought into collision with a metal or the like to produce toner, the resulting toner is apt to be cracked.

Japanese Patent Laid-Open No. 1999-72968 discloses a toner for developing an electrostatic image obtained by the polymerization in the presence of a charge control agent composed of a polymer with an epoxy structure and a sulfur-containing or a phosphorus-containing structure. The toner disclosed in the above document, while it is excellent in anti-offset, low-temperature fixation, storage stability and the like, provides an image density that needs further improvement.

Japanese Patent Application Laid-Open No. 1998-48883 discloses an electrophotographic toner comprising colored fine particles using an epoxy-based resin as a dispersant for dispersing pigments in a polymerizable monomer. The epoxy-based resin used in the document includes an epoxy resin and a precursor of an epoxy resin. The precursor is generally composed of a multifunctional epoxy compound, to which a curing accelerator such as an amine compound is added, to form an epoxy resin by the ring opening polymerization between epoxy groups. The epoxy-based resin is used as a dispersant of pigments. The curing reaction of the epoxy resin is so fast that an unreacted epoxy group is consumed fast, so that it can hardly be expected that the epoxy resin exhibits the effect for dispersing pigments.

Thus, a toner that is excellent in dispersibility of the pigment and can provide good images is eagerly desired.

The object of the present invention is to provide a toner that is excellent in dispersibility of the pigment and can provide good images.

### DISCLOSURE OF THE INVENTION

The inventor of the present invention carried out an in-depth study to accomplish the object. As a result, he has found that this object can be accomplished by; using a toner, wherein the filtrate obtained by filtering a dispersion of the toner in tetrahydrofuran has a maximum absorption in a specific range with a specific range of absorbance, when it is measured by a spectrophotometer.

The present invention has been accomplished based on the above finding. According to the present invention, there is provided a toner comprising at least a pigment and a binder resin, wherein filtrate obtained by filtering a dispersion comprising 0.2 g of the toner dispersed in 100 ml of tetrahydrofuran through a filter with a pore size of 0.45 μm, when it is measured by a spectrophotometer, has a maximum absorption between 380 nm and 440 nm wherein the absorbance at the maximum absorption is 1 or higher, or has a maximum absorption between 640 nm and 680 nm wherein the absorbance at the maximum absorption is 0.2 or higher, or has a maximum absorption between 490 nm and 560 nm wherein the absorbance at the maximum absorption is 0.15 or higher.

The above described filtrate preferably has the ratio A/(A+B) of 0.1 or more for the peak detected at a wavelength of 410 nm or 540 nm by a UV detector, wherein A denotes the area of a region where the molecular weight exceeds 2,000 and B denotes the area of a region where the molecular weight is from 500 to 2,000, when measured by gel permeation chromatography.

The above described filtrate preferably has a basicity of 10 mmol/g or less.

The toner of the present invention preferably further comprises a charge control resin.

The above described charge control resin preferably has a weight average molecular weight from 2,000 to 50,000.

The toner of the present invention preferably further comprises a parting agent.

The above described parting agent is preferably a multifunctional ester compound.

The pigment contained in the toner of the present invention includes those having the following structure:
—N=N—CH(COCH₃)—CONH—
in a molecular structure thereof.

In addition, the pigment contained in the toner of the present invention includes a phthalocyanine pigment.

Preferably, the toner of the present invention has a volume average particle diameter (Dv) in the range from 3 to 10 μm, the ratio (Dv/Dp) of the volume average particle diameter (Dv) to the number average particle diameter (Dp) in the range from 1 to 1.3, and the ratio (rl/rs) of the length (rl) to the breadth (rs) of the particle in the range from 1 to 1.2.

The toner of the present invention preferably has a tetrahydrofuran-insoluble content in the range from 0 to 80% by weight.

The toner of the present invention preferably has a pH of the aqueous extract solution in the range from 4 to 7.

In the toner, a number of pigment particles having a length of at least 0.2 μm counted in an area of 100 μm×100 μm of a toner having a thickness of 20 μm, which is prepared by melting the toner at a temperature of 170° C., is preferably at most 50.

Moreover, the present invention provides a method for producing a toner comprising a step of polymerizing, in an aqueous dispersion medium, a polymerizable monomer composition comprising a polymerizable monomer and a pigment, characterized in that the above described polymerizable monomer composition comprises an epoxy compound or an acid halide, having radical polymerizability.

In the method for producing a toner according to the present invention, the content of the epoxy compound or the acid halide in the polymerizable monomer composition is preferably in the range from 0.1 to 5 parts by weight per 100 parts by weight of the polymerizable monomer.

In the method for producing a toner according to the present invention, the polymerizable monomer composition preferably further comprises a charge control resin.

The above described charge control resin preferably has a weight average molecular weight in the range from 2,000 to 50,000.

### BEST MODE FOR CARRYING OUT THE INVENTION

A toner according to the present invention is described in detail below.

The toner of the present invention comprises at least a pigment and a binder resin.

Resins that have conventionally been used as a binder resin for a toner can be used as the binder resin. Examples of the binder resin include polymers of styrene and substituted derivatives thereof such as polystyrene and polyvinyltoluene; styrenenic copolymers such as a styrene-methyl acrylate copolymer, a styrene-ethyl acrylate copolymer, a styrene-butyl acrylate copolymer, a styrene-2-ethylhexyl acrylate copolymer, a styrene-methyl methacrylate copolymer, a styrene-ethyl methacrylate copolymer, a styrene-butyl methacrylate copolymer and a styrene-butadiene copolymer; polymethylmathacrylate, polyesters, epoxy resins, polyvinyl butyral, aliphatic or alicyclic hydrocarbon resins, polyolefins, (meth)acrylate resins, norbornene resins and respective hydrogenated products of styrenic resins.

As a polymerizable monomer for obtaining the binder resin, there can be mentioned, for instance, a monovinyl monomer, a cross-linkable monomer and a macromonomer. These polymerizable monomers are polymerized to form a binder resin component in a toner particles.

Specific examples of the monovinyl monomers include: aromatic vinyl monomers such as styrene and vinyl toluene; acrylic acid and its derivatives such as methyl acrylate, ethyl acrylate, propyl acrylate, butyl acrylate, 2-etylhexyl acrylate, cyclohexyl acrylate, dimethylaminoethyl acrylate and acrylamide; methacrilic acid and its derivatives such as methyl methacrylate, ethyl methacrylate, propyl methacrylate, butyl methacrylate, 2-etylhexyl methacrylate, cyclohexyl methacrylate, dimethylaminoethyl methacrylate and methacrylamide; and the like.

The monovinyl monomers may be used alone or in combination. Among the monovinyl monomers as mentioned above, it is preferable to use aromatic vinyl monomers alone, or to use aromatic vinyl monomers in combination with (meth)acrylic acid derivatives.

The use of the cross-linkable monomer in combination with the monovinyl monomer effectively improves hot offset resistance of the resulting toner. The cross-linkable monomer refers to a monomer which has two or more polymerizable carbon-carbon unsaturated double bonds. Specific examples of the cross-linkable monomers include aromatic divinyl compounds such as divinylbenzene, divinylnaphthalene and derivatives thereof; compounds with two vinyl groups in a molecule such as ethylene glycol dimethacrylate, diethylenically unsaturated carboxylates such as diethylene glycol dimethacrylate and divinyl ether; and compounds with three or more vinyl groups in a molecule such as pentaerythritol triallyl ether and trimethyrol propane triacrylate; and the like.

The cross-linkable monomers may be used alone or in combination of two or more. The amount of the cross-linkable monomers to be used is preferably 10 parts by weight or less, more preferably 0.1 to 2 parts by weight, per 100 parts by weight of the monovinyl monomer.

In the present invention, a macromonomer can be used as a monomer. Additional use of a macromonomer together with a monovinyl monomer is preferable to balance the shelf stability and the fixability at a low temperature of a resultant toner. The macromonomer is an oligomer or polymer having a vinyl-polymerizable functional group at its molecular chain terminal and has a number average molecular weight preferably in the range of 1,000 to 30,000. Use of a macromonomer with a number average molecular weight of less than 1,000 may soften a surface part of toner, resulting in degradation of the shelf stability. On the other hand, use of a macromonomer with a number average molecular weight of higher than 30,000 may degrade the melting property of the macromonomer, resulting in degradation of the fixability and shelf stability. The vinyl-polymerizable functional group includes an acryloyl group, a methacryloyl group and the like. A methacryloyl group is preferred in terms of the ease of copolymerization.

The macromonomer is preferably the one which gives a polymer, by polymerization alone, having a glass transition temperature higher than that of a polymer obtained by polymerizing the above-mentioned monovinyl monomers.

Specific examples of the macromonomer to be used in the present invention include macromonomers comprising polymers obtained by polymerizing styrene, styrene derivatives, methacrylates or acrylates, alone or in combination of two or more. Among the above described polymers, hydrophilic polymers, in particular, polymers obtained by polymerizing methacrylates or acrylates, alone or in combination, are preferably used.

When the macromonomer is used in combination, the amount of the same to be used is preferably 0.01 to 10 parts by weight, more preferably 0.03 to 5 parts by weight, most preferably 0.05 to 1 part by weight, per 100 parts by weight of a monovinyl monomer. Use of the macromonomer in an amount of less than 0.01 part by weight may deteriorate the shelf stability of a toner. On the other hand, use of the macromonomer in an amount of more than 10 parts by weight may degrade the fixability.

The above described binder resin is preferably mixed with a radical polymerizable epoxy compound or a radical polymerizable acid halide in order to improve the dispersibility of pigments and to prevent reaggregation thereof.

As the radical polymerizable epoxy compounds, there can be mentioned; glycidyl methacrylate, glycidyl acrylate, allyl glycidyl ether, styryl glycidyl ether, epoxy resins and the like.

As the radically polymerizable acid halides, there can be mentioned; chloride compounds such as acryloyl chloride, methacryloyl chloride, styrene carbonyl chloride, styrene sulfonyl chloride, 2-methacryloyloxy ethyl succinyl chloride, 2-methacryloyloxy ethyl hexahydrophthalyl chloride; bromide compounds such as acryloyl bromide, methacryoyl bromide, styrene carbonyl bromide, styrene sulfonyl bromide, 2-methacryloyloxy ethyl succinyl bromide, 2-methacryloyloxy ethyl hexahydrophthalyl bromide; and the like.

When radically polymerizable epoxy compounds or acid halides are mixed, the amount to be mixed is preferably 0.1 to 5% by weight, more preferably 0.2 to 3% by weight, in the polymerizabl emonomers to be used for forming binder resin components. If the content of the epoxy compound or acid halide is less than 0.1% by weight, the effect for dispersing pigments may be inadequate. On the other hand, if the content of the epoxy compound or acid halide exceeds 5% by weight, hot offset may occur. Both cases may degrade image quality.

The radically polymerizable epoxy compound or acid halide may be used alone or in combination of two or more.

Pigments to be contained in the toner of the present invention include, for example, yellow pigments, cyan pigments and magenta pigments.

As the yellow pigments, those having the following structure:
—N=N—CH(COCH₃)—CONH—
in a molecular structure thereof are preferred.

Specific examples of yellow pigments include C.I. Pigment Yellow 3, 12, 13, 14, 16, 17, 55, 65, 73, 83, 94, 95, 97, 120, 151, 154, 167, 169, 172, 180, 181 and the like.

As cyan pigments, there can be mentioned phthalocyanine-copper compounds or their derivatives, anthraquinone compounds and the like. Specific examples of cyan pigments include C.I. Pigment Blue 2, 3, 6, 15, 15:1, 15:2, 15:3, 15:4, 16, 17, 60 and the like. Among the above described cyan pigments, phthalocyanine-copper compounds are particularly preferred.

As magenta pigments, there can be mentioned azo pigments and condensed polycyclic pigments such as naphthol-based pigments, quinacridon-based pigments and the like. Preferred pigments among them are those whose aqueous dispersion prepared by dispersing 6 g of a pigment in 100 g of water has a pH of less than 7. Specific examples of magenta pigments include C.I. Pigment Red 3, 48, 57, 57.1, 58, 60, 63, 64, 68, 81, 83, 114, 122, 123, 144, 146, 149, 150, 151, 163, 170, 171, 175, 176, 177, 178, 179, 184, 185, 187, 202, 206, 207, 209, 251 and the like and C.I. Pigment Violet 19 and the like.

The above described pigments may be used preferably in the range of 1 to 10 parts by weight per 100 parts by weight of polymerizable monomers.

The toner of the present invention preferably comprises a charge control agent. As the charge control agent, conventional charge control agents used for toners can be used without any limitation.

Among the charge control agents, it is preferable to use charge control resins. These charge control resins are preferably used in the present invention, since they have high compatibility with binder resins, are colorless, and can provide a toner with a stable charging property even when it is used in high-speed continuous color printing. For example, the above described pigments are preferably kneaded with charge control resins for use in toner.

Charge control resins include a negative charge control resin and a positive charge control resin. One of them is preferably selected depending on whether the toner of the present invention is prepared as a negatively charged toner or a positively charged toner. A negative charge control resin and a positive charge control resin are described in detail below.

As the negative charge control resins, there can be mentioned resins having a substituent, in the side chain of a polymer, selected from a carboxyl group or its salt, a phenol group or its salt, a thiophenol group or its salt or a sulfonic acid group or its salt; and the like.

As the salt of the above described substituent contained in the side chain of a polymer, there can be mentioned a salt with a metal such as zinc, magnesium, aluminum, sodium, calcium, chromium, iron, manganese or cobalt; and a salt with organic bases such as ammonium ion, pyridinium ion or imidazolium ion.

Among the above described resins, those having a sulfonic acid group or its salt in the side chain of a polymer are preferably used. Specific examples include resins obtained by copolymerizing a monovinyl monomer having a sulfonic acid group or its salt with another monovinyl monomer copolymerizable with the above described monovinyl monomer. Another monovinyl monomer copolymerizable with the monovinyl monomer includes an ethylenically unsaturated carboxylate monomer, an aromatic vinyl monomer, an ethylenically unsaturated nitrile monomer or the like.

As the monovinyl monomer having a sulfonic acid group or its salt, there can be mentioned styrene sulfonic acid, sodium styrene sulfonate, potassium styrene sulfonate, 2-acrylamido-2-methylpropane sulfonic acid, sodium vinyl sulfonate, ammonium methacryl sulfonate and the like.

As the ethylenically unsaturated carboxylate monomer, there can be mentioned methyl acrylate, ethyl acrylate, propyl acrylate, butyl acrylate, 2-ethylhexyl acrylate, methyl methacrylate, ethyl methacrylate, propyl methacrylate, butyl methacrylate, 2-ethylhexyl methacrylate and the like.

As the aromatic vinyl monomer, there can be mentioned styrene, methylstyrene, vinyl toluene, chlorostyrene, hydroxymethylstyrene and the like.

As the ethylenically unsaturated nitrile monomer, there can be mentioned acrylonitrile, methacrylonitrile, fumaronitrile, α-chloroacrylonitrile, α-cyanoethyl acrylonitrile and the like.

The amount of a monovinyl monomer having a sulfonic acid group or its salt to be mixed is preferably 0.5 to 15% by weight, more preferably 1 to 10% by weight, in a negative charge control resin. If the amount of the monovinyl monomer having a sulfonic acid group or its salt to be mixed is less than 0.5% by weight, the dispersibility of pigments may be inadequate to reduce image density and transparency. On the other hand, if the amount of the monovinyl monomer having a sulfonic acid group or its salt to be mixed exceeds 15% by weight, the reduction of a charge amount under high-temperature and high-humidity may be increased to cause fog.

Preferred as the negative charge control resin is that having a weight average molecular weight of 2,000 to 50,000, more preferably 4,000 to 40,000, most preferably 6,000 to 35,000. If the weight average molecular weight of the negative charge control resin is less than 2,000, a mixture for manufacturing a toner tends to have a too low viscosity during mixing and a pigment tends to disperse non-uniformly.

The glass transition temperature of the negative charge control resin is preferably 40 to 80° C., more preferably 45 to 75° C., most preferably 45 to 70° C. If the glass transition temperature of the negative charge control resin is below 40° C., shelf stability of the resulting toner may become deteriorated. If the glass transition temperature exceeds 80° C., fixability of the resulting toner may lower.

As the positive charge control resin , there can be mentioned: resins having an amino group such as —NH₂, —NHCH₃, —N(CH₃)₂, —NHC₂H₅, —N(C₂H₅)₂, and —NHC₂H₄OH; and resins having a functional group of an ammonium salt which is obtained from the above described amino groups. These resins can be obtained, for example, by copolymerizing a monovinyl monomer having an amino group with a monovinyl monomer copolymerizable with the same. Further, the copolymer obtained as described above can be modified to the ammonium salt thereof to obtain the resin. Furthermore, these resins can also be obtained by copolymerizing a monovinyl monomer having an ammonium salt group with a monovinyl monomer copolymerizable with the same. However, methods for obtaining these resins are not limited to the above described methods. Examples of the monovinyl monomer copolymerizable with a monovinyl monomer having an amino group and the monovinyl monomer copolymerizable with a monovinyl monomer having an ammonium salt group include those used for obtaining the negative charge control resins.

As the monovinyl monomer having an amino group, there can be mentioned: acrylamide-based monomers such as acrylamide, N-methyl acrylamide, N,N-dimethyl acrylamide and N-ethyl acrylamide; methacrylamide-based monomers such as methacrylamide, N-methylmethacrylamide, N,N-dimethylmethacrylamide and N-ethyl methacrylamide; acrylic acid derivatives such as 3-(dimethylamino)propyl acrylate; methacrylic acid derivatives such as 3-(dimethylamino)propyl methacrylate; allylamine; styrene derivatives such as 2-aminostyrene and 4-aminostyrene; and the like.

As the chemicals for modifying the copolymers to the corresponding ammonium salts, those chemicals conventionally used in this field can be used. Specific examples of the chemicals include: alkyl halides such as methyl iodide, ethyl iodide, methyl bromide and ethyl bromide; alkyl p-toluene sulfonates such as methyl p-toluene sulfonate, ethyl p-toluene sulfonate and propyl p-toluene sulfonate; and the like.

The amount of the monovinyl monomer having a functional group such as an amino group or an ammonium salt group to be mixed in the positive charge control resin is preferably 0.5 to 15% by weight, more preferably 1 to 10% by weight. If the content of the monovinyl monomer having a functional group is less than 0.5% by weight, the dispersibility of a pigment may be inadequate to reduce image density and transparency. On the other hand, if the content of the monovinyl monomer having a functional group exceeds 15% by weight, the reduction of a charge amount under high-temperature and high-humidity may be increased to cause fog.

Preferred as the positive charge control resin is that having a weight average molecular weight of 2,000 to 30,000, more preferably 4,000 to 25,000, most preferably 6,000 to 20,000. If the weight average molecular weight of the positive charge control resin is less than 2,000, a mixture for manufacturing a toner tends to have a too low viscosity during mixing and a pigment tends to disperse non-uniformly.

The glass transition temperature of the positive charge control resin is preferably 40 to 100° C., more preferably 45 to 80° C., most preferably 45 to 70° C. If the glass transition temperature is below 40° C., shelf stability of the resultant toner may become deteriorated. If the glass transition temperature exceeds 100° C., fixability of the resultant toner may lower.

In a toner of the present invention, the above described negative charge control resin and positive charge control resin may be used at the same time. The preferable proportion of the charge control resins varies depending on whether the resultant electrostatically charged image-developing toner is prepared as a negatively charged toner or a positively charged toner. For obtaining a negatively charged toner, it is necessary to control so that the molar equivalent of a functional group (such as a sulfonic acid group) providing a negative charging property in a negative charge control resin is larger than that of a functional group (such as a quaternary ammonium group) providing a positive charging property in a positive charge control resin. For obtaining a positively charged toner, it is necessary to control contrarily.

The amount of above described charge control agent used is preferably 0.01 to 30 parts by weight, more preferably 0.3 to 25 parts by weight, per 100 parts by weight of the polymerizable monomer to be used for obtaining the binder resin.

In the present invention, a parting agent may be preferably used as additives for the toner in terms of improving a low-temperature fixability, preventing filming and the like.

As the parting agent, there can be mentioned: polyolefin waxes such as low molecular weight polyethylene and low molecular weight polypropylene; natural plant waxes such as candelilla, carnauba wax, rice and wood wax; petroleum waxes such as paraffin, microcrystalline wax and petrolactam, and denaturations thereof; mineral waxes such as montan and ceresin; synthetic waxes such as Fischer Tropsch wax; multifunctional ester compounds such as pentaerythritol tetramyristate, pentaerythritol tetrapalmitate and dipentaerythritol hexamyristate; and the like

Among these parting agents, synthetic waxes (particularly Fischer Tropsch wax) and polyfunctional ester compounds are preferred. Polyfunctional ester compounds are more preferred, which show an endothermic peak temperature within the range of, preferably 30° C. to 150° C., more preferably 50° C. to 120° C., and most preferably 60° C. to 100° C., measured with a DSC curve by means of a differential scanning calorimeter (DSC) at rising temperature, because a toner excellent in a balance between fixing-peeling property during fixing is obtained. Of these, a dipentaerythritol ester compound, which has a molecular weight of 1,000 or more, is soluble in styrene at 25° C. in the proportion of 5 parts by weight or more based on 100 parts by weight of styrene, and has an acid value of 10 mgKOH/g or less, is even more preferred, because it exhibits a distinguished effect in lowering the fixing temperature. The above-mentioned endothermic peak temperatures refer to values measured in accordance with ASTM D3418-82. The amount of the parting agent is preferably 0.1 to 20 parts by weight, more preferably 1 to 15 parts by weight, per 100 parts by weight of the polymerizable monomer for forming the binder resin.

The parting agent may be used alone or in combination of two or more.

A toner of the present invention may be a particles with a core-shell structure (also called “capsule type”). A core-shell structured particles is preferred in that the balance of the reduction of fixing temperature and prevention of aggregation during storage can be achieved by covering the inner part (core layer) made of a material having a low softening point with a material having a higher softening point than that of the inner part. A core monomer for forming the core layer can include a monomer similar to a polymerizable monomer for forming a binder resin.

For a core-shell type toner, a polymer forming a core layer has a glass transition temperature preferably in the range of 0 to 80° C., more preferably in the range of 40 to 60° C. If the glass transition temperature exceeds 80° C., fixing temperature may be higher, and on the other hand, if the glass transition temperature is lower than 0° C., shelf stability may decline.

Moreover, it is necessary to set the glass transition temperature of a polymer forming a shell layer to be higher than that of a polymer forming a core layer. The glass transition temperature of a polymer forming a shell layer is preferably 50 to 130° C., more preferably 60 to 120° C., and most preferably 80 to 110° C., in order to improve the shelf stability of a toner. If the glass transition temperature is below 50° C., the shelf stability may be degraded. On the other hand, if the glass transition temperature exceeds 130° C., the fixability may be degraded. Styrene, acrylonitrile, methyl methacrylate and the like are preferably used as the shell monomer forming a shell layer.

The difference between the glass transition temperature of a polymer forming a core layer and that of a polymer forming a shell layer is preferably 10° C. or more, more preferably 20° C. or more, and most preferably 30° C. or more. If the difference is smaller than the above described values, the balance of shelf stability and a fixing property may be degraded.

The proportion by weight of the core layer to the shell layer of the core-shell structure toner is not particularly limited, but is preferably in the range (core layer/shell layer) from 80/20 to 99.9/0.1.

If the proportion by weight of the shell layer is smaller than the above range, shelf stability may be deteriorated, and on the other hand, when the proportion by weight of the shell layer is larger than the above range, low-temperature fixing may be difficult.

The filtrate obtained by filtering a toner dispersion comprising 0.2 g of the toner according to the present invention dispersed in 100 ml of tetrahydrofuran through a filter with a pore size of 0.45 μm, when it is measured by a spectrophotometer, has a maximum absorption between 380 nm and 400 nm wherein the absorbance at the maximum absorption is 1 or higher, or has a maximum absorption between 640 nm and 680 nm wherein the absorbance at the maximum absorption is 0.2 or higher, or has a maximum absorption between 490 nm and 560 nm wherein the absorbance at the maximum absorption is 0.15 or higher. If the absorbance at the maximum absorption is smaller than the above described range, dispersion of pigments in the toner is not adequate, resulting in reduction of the image density after fixing.

When the filtrate obtained by filtering a toner dispersion comprising 0.2 g of the toner according to the present invention dispersed in 100 ml of tetrahydrofuran through a filter with a pore size of 0.45 μm is measured by a spectrophotometer, the maximum absorption range varies depending on the pigment used. Specifically, when a yellow pigment is used as a pigment, the above described filtrate has a maximum absorption between 380 nm and 400 nm, preferably between 390 nm and 420 nm, when the filtrate is measured by a spectrophotometer. In addition, the absorbance at the maximum absorption is 1 or more, preferably 1.5 or more, and more preferably 2 or more.

When a cyan pigment is used as a pigment, the above described filtrate has a maximum absorption between 640 nm and 680 nm, preferably between 650 nm and 670 nm, when the filtrate is measured by a spectrophotometer. In addition, the absorbance at the maximum absorption is 0.2 or more, preferably 0.3 or more, and more preferably 0.6 or more.

When a magenta pigment is used as a pigment, the above described filtrate has a maximum absorption between 490 nm and 560 nm, preferably between 500 nm and 540 nm, when the filtrate is measured by a spectrophotometer. In addition, the absorbance at the maximum absorption is 0.15 or more, preferably 0.3 or more, and more preferably 0.6 or more.

The filtrate obtained by filtering a toner dispersion comprising 0.2 g of the toner according to the present invention dispersed in 100 ml of tetrahydrofuran through a filter with a pore size of 0.45 μm, when it is measured by a spectrophotometer, preferably has a color difference ΔE of 15 or more, more preferably 30 or more, relative to tetrahydrofuran, in the case where a yellow pigment is used as the pigment in the toner. Further, in the case where a cyan pigment is used as the pigment in the toner, the filtrate prepared as described above preferably has a color difference ΔE of 10 or more, more preferably 30 or more, relative to tetrahydrofuran, when it is measured by a spectrophotometer. Furthermore, in the case where a magenta pigment is used as the pigment in the toner, the filtrate prepared as described above preferably has a color difference ΔE of 5 or more, more preferably 10 or more, relative to tetrahydrofuran, when it is measured by a spectrophotometer. When the color difference ΔE is below the above described range, dispersion of the pigment in the toner may be inadequate, resulting in reduction of the image density after fixing.

The above described filtrate preferably has a ratio A/(A+B) of 0.1 or more, more preferably 0.3 or more for the peak detected at a wavelength of 410 nm (in the case where a yellow pigment is used as a pigment) or 540 nm (in the case where a magenta pigment is used as a pigment) by a UV detector, wherein A denotes the area of a region where the molecular weight exceeds 2,000 and B denotes the area of a region where the molecular weight is from 500 to 2,000, when the filtrate is measured by gel permeation chromatography. If A/(A+B) is less than 0.1, the image density after fixing may be reduced.

When a magenta pigment is used as a pigment, the above described filtrate preferably has a basicity of 10 mmol/g or less, preferably 0.1 to 7 mmol/g. Since a magenta color pigment preferably used in the toner of the present invention has high cohesion, for producing a toner of the present invention, a radically polymerizable epoxy compound or an acid halide is contained. For example, when an acidic resin having a sulfonic acid group is used as a charge control resin, it is preferable to add a base to a polymer to form a salt of a magenta color pigment. Therefore, it is preferable that a base be contained in the toner of the present invention, and that the basicity of the filtrate is preferably within the above described range. Incidentally, the base to be used is described below.

The toner of the present invention has a volume average particle diameter (Dv) of, preferably, 3 to 10 μm, more preferably 4 to 8 μm. If Dv is less than 3 μm, the charge amount of a toner is reduced to cause fog, and on the other hand, if Dv exceeds 10 μm, resolution may decline.

The toner of the present invention has the ratio (Dv/Dp) of the volume average particle diameter (Dv) to the number average particle diameter (Dp) , i.e. the ratio (Dv/Dp) of, generally, 1 to 1.3, preferably 1 to 1.2. If Dv/Dp exceeds 1.3, transfer property may be degraded and fog may be occured.

Moreover, the value (rl/rs) obtained by dividing the length (rl) by the breadth (rs) of the toner is preferably 1 to 1.2, more preferably 1 to 1.1. When this value is larger than 1.2, transfer property for transferring a toner image on a photoconductive member to a recording material such as paper may be degraded; and the friction between toners may be increased when this toner is contained in the toner-containing part of an image-forming apparatus, leading to peeling of external additives, which may result in degradation of durability.

The toner of the present invention has the pH of the aqueous extract solution thereof, preferably, 4 to 7, more preferably 5 to 7. If the pH of the aqueous extract solution is less than about 4, environmental stability of the toner may be deteriorated. On the other hand, if the pH exceeds about 7, the environmental stability may be deteriorated. Specifically, the pH of the aqueous extract solution of a toner is determined by dispersing 6 g of the toner in 100 g of ion-exchanged water with a pH of about 7, heating and boiling the dispersion for 10 minutes, and then measuring the pH of the dispersion.

The toner of the present invention has a melt viscosity at 120° C. of, preferably, 10,000 Pa·s or less, more preferably 100 to 10,000 Pa·s, and most preferably 1,000 to 8,000 Pa·s. If a melt viscosity at 120° C. is within the above described range, a high-quality image can be achieved even by a high-speed printing. Specifically, the viscosity can be measured by means of a flow tester.

Moreover, the softening temperature determined by a flow tester is preferably 50 to 80° C., more preferably 60 to 70° C.; and the flow starting temperature is preferably in the range of 90 to 150° C., more preferably in the range of 100 to 130° C. If the softening temperature is below 50° C., shelf stability may be degraded. On the other hand, If the softening temperature exceeds 80° C., fixability may be degraded. When the flow starting temperature is below 90° C., hot-offset resistance may be degraded. On the other hand, when it exceeds 130° C., fixability may be degraded.

The toner of the present invention has a glass transition temperature determined by a differential scanning calorimeter of, preferably, 0 to 80° C., more preferably 40 to 70° C. If the glass transition temperature is below 0° C., shelf stability may be degraded, and on the other hand, If the glass transition temperature exceeds 80° C., fixability may be degraded.

The toner of the present invention has a tetrahydrofuran (THF)-insoluble content (also called “gel content”) of, preferably, 0 to 80% by weight, more preferably in the range of 0 to 60% by weight, and most preferably in the range of 0 to 40% by weight. If the THF-insoluble content exceeds 50%, reduction of gloss and transparency may occur. The THF-insoluble content can be determined by a method to be described below.

The toner of the present invention has a volume resistivity value (log (Ω·cm) ) determined by a dielectric loss measuring device preferably, in the range of 10 to 13, more preferably in the range of 10.5 to 12.5. If the volume resistivity value is below 10, fog may be developed. On the other hand, If the volume resistivity value exceeds 13, toner scattering, fog, filming or poor cleaning may occur.

The toner of the present invention preferably shows little change in the charge amount in a high-temperature and high-humidity environment (H/H environment) and in a low-temperature and low-humidity environment (L/L environment), that is, it preferably has high so called environmental stability. Specifically, the change in the charge amount between each environment is preferably below 5 μC/g. When the environmental stability is low, fog may be developed.

In the toner of the present invention, the number of particles of coloring pigment having the length of at least 0.2 μm, counted in an area of 100 μm×100 μm of the toner having a thickness of 20 μm, which is prepared by melting the toner at a temperature of 170° C., is preferably 50 or less, more preferably 30 or less, and most preferably 20 or less. If the number of coloring pigment particles with a length of 0.2 μm or more is large, spectral characteristics such as transparency required for the reproduction of sharp colors of color images may be degraded; fog may increase; and printing density may be reduced. The spectral characteristics can be determined by performing printing solid pattern by color using a commercially available printer and measuring the color using a spectrophotometer.

It is preferable to limit the amount of remaining metal (ion) in the toner of the present invention. In particular, when metal (ion) such as magnesium or calcium remains in a developer, the developer may absorb moisture under a high humidity environment to reduce the flowability thereof, adversely affecting the image quality. A developer in which the content of magnesium or calcium (hereinafter simply referred to as remaining metal) is low can give good image quality with high printing density and no fog by means of a high-speed printer that can print 30 sheets or more in a minute even under a high-temperature and high-humidity environment. The content of remaining metal in toner is preferably 170 ppm or less, more preferably 150 ppm or less, and most preferably 120 ppm or less. A method for reducing the content of remaining metal in a toner include, for example, a method for repeatedly dewatering and washing the toner using a washing/dehydrating machine such as a continuous belt filter or a siphon peeler centrifuge and the like in a dehydration step of a toner production process, and then drying the resultant toner.

The followings are detailed description about the method for producing a toner of the present invention. The toner of the present invention may be produced by mixing a pigment, a charge control resin, other additives and the like to a polymerizable monomer that is a raw material for a binder resin, forming droplets of the mixture in water, polymerizing the monomer by a method such as suspension polymerization, emulsion polymerization, precipitation polymerization, soap-free polymerization or the like, and associating the resulting polymer particles with each other, if necessary. Suspension polymerization is preferably used in that pigments can be uniformly dispersed and a charging property and transferring property can be improved. Hereinafter, a method for producing a toner by suspension polymerization is described.

This method for producing a toner comprises a step of polymerizing, in an aqueous dispersion medium, a polymerizable monomer composition comprising a polymerizable monomer and a pigment, characterized in that the above described polymerizable monomer composition comprises an epoxy compound or an acid halide, having radical polymerizability. As described above, polymerization of a polymerizable monomer composition comprising a radically polymerizable epoxy compound or an acid halide can provide a toner excellent in dispersibility of the pigment.

When a magenta pigment is used as a pigment, it is preferable to improve dispersibility by adding a base, since a magenta pigment has a strong cohesion. As the base to be used, there can be mentioned; alcoholates or hydroxides of Na, K, Li and Mg; hydrides of NaBH₄ and the like; and the like. The amount of the above described base to be used is preferably 0.05 to 10 parts by weight, more preferably 0.2 to 2 parts by weight, relative to 100 parts by weight of a polymerizable monomer.

The pigment to be used in the method for producing a toner of the present invention may be added in the form of a charge control resin composition in which the pigment is mixed with a charge control resin.

An organic solvent is used for preparing the charge control resin composition, if necessary. When an organic solvent is used, a charge control resin may be dissolved or swelled in the organic solvent before mixing. On the other hand, when an organic solvent is not used, it is necessary to warm a charge control resin to a temperature where the resin is softened, before mixing. When an organic solvent is used, the mixing is preferably performed in room temperature or under cooling, since an organic solvent may evaporate by warming, depending on the boiling point of the organic solvent. Incidentally, since the problem of bad smell may occur when an organic solvent remains in a toner, the organic solvent is preferably removed when a charge control resin composition is produced or after the toner is produced.

Mixing of the charge control resin and the colorant may be performed using equipment such as a roll, a kneader, a single screw extruder, a twin screw extruder, a Banbury mixer, a Buss co-kneader, and the like. When an organic solvent is used, it is preferred to use the mixing equipment in a closed system with a structure which prevents leakage of the organic solvent to the outside to avoid the problem of bad smell and toxicity. Moreover, it is preferable to use the mixing equipment having a torque meter, because the torque meter enables to monitor the torque level and control the dispersibility.

As described above, the toner includes a single layer toner and a core-shell type toner. The followings are detailed description about the method for producing the core-shell type toner.

A core particle is produced by suspending a polymerizable monomer composition (polymerizable monomer composition for core) comprising a polymerizable monomer (polymerizable monomer for core) , a charge control resin composition in which a pigment is dispersed and other additives, if necessary, in an aqueous dispersion medium containing a dispersion stabilizer, and polymerizing the polymerizable monomer for core with a polymerization initiator. Next, a core-shell type toner can be obtained by further adding a polymerizable monomer (polymerizable monomer for shell) and a polymerization initiator to the resulting mixture as described above, and polymerizing the polymerizable monomer for shell.

As specific examples of the process for forming the shell, there can be mentioned: a process in which a polymerizable monomer for shell is added to the above-mentioned reaction system of the polymerization reaction performed to obtain the core particles, and polymerized in-situ continuously; and a process in which core particles obtained in a reaction system are provided into another reaction system and a polymerizable monomer for shell is added and then polymerized. The polymerizable monomer for shell can be added at once, or continuously or intermittently using a pump such as a plunger pump and the like.

As the polymerization initiator, there can be mentioned; persulfates such as potassium persulfate and ammonium persulfate; azo compounds such as 4,4′-azobis(4-cyanovaleric acid), 2,2′-azobis(2-methyl-N-(2-hydroxyethyl)propionamide), 2,2′-azobis(2-amidinopropane)dihydrochloride, 2,2′-azobis(2,4-dimethylvaleronitrile) and 2,2′-azobisisobutyronitrile; peroxides such as di-t-butyl peroxide, benzoyl peroxide, t-butyl peroxy-2-ethylhexanoate, t-hexyl peroxy-2-ethylhexanoate, t-butyl peroxypivalate, diisopropyl peroxydicarbonate, di-t-butyl peroxyisophthalate and t-butyl peroxyisobutylate; and the like. In addition, redox initiators, which is prepared by combining the above described polymerization initiator with a reducing agent, may also be used.

Among the above described polymerization initiators, an oil-soluble polymerization initiator is preferably used to polymerize a polymerizable monomer for core, and a water-soluble polymerization initiator is preferably used to polymerize a polymerizable monomer for shell.

The amount of the polymerization initiator for use in the polymerization of the polymerizable monomer for core is preferably 0.1 to 20 parts by weight, more preferably 0.3 to 15 parts by weight, and most preferably 0.5 to 10 parts by weight, relative to 100 parts by weight of the polymerizable monomer. The polymerization initiator may be added in the polymerizable monomer composition in advance, or may optionally be added to the suspension after completing the step of forming droplets. The amount of the polymerization initiator for polymerizing the polymerizable monomer for shell is, on the basis of an aqueous medium, generally 0.1 to 50 parts by weight, preferably 1 to 30 parts by weight, relative to 100 parts by weight of the polymerizable monomer. If the amount is less than 0.1 part by weight, polymerization may proceed more slowly, reducing productivity. On the other hand, If the amount exceeds 50 parts by weight, the molecular weight of a resulting polymer may be reduced, degrading shelf stability.

Moreover, at the time of polymerization, a dispersion stabilizer may be added to the reaction system. As the dispersion stabilizer, there can bementioned; metal salts such as sulfates such as calcium sulfate, carbonates such as calcium carbonate and magnesium carbonate, and phosphates such as calcium phosphate; metal hydroxides such as aluminum hydroxide, magnesium hydroxide and ferric hydroxide; water-soluble polymers such as polyvinyl alcohol, methylcellulose and gelatin; anionic surfactants, nonionic surfactants and amphoteric surfactants; and the like. These dispersion stabilizers may be used alone or in combination of two or more.

Among the above dispersion stabilizers, a dispersion stabilizer comprising a colloid of a hardly water-soluble metal hydroxide is particularly preferred, since it can narrow the particle size distribution of a polymer particles; the remaining amount of the dispersion stabilizer after washing is small; and it can sharply reproduce images. The dispersion stabilizer comprising a colloid of a hardly water-soluble metal hydroxide is not limited by the production methods thereof. However, a colloid of a hardly water-soluble metal hydroxide obtained by increasing the pH of an aqueous solution of a water-soluble multivalent metal compound to 7 or higher, particularly a colloid of a hardly water-soluble metal hydroxide produced by reacting a water-soluble multivalent metal compound with a hydroxide of an alkali metal, is preferably used.

When a colloid of a hardly water-soluble metal hydroxide is used, it preferably has a number particle diameter distribution D50 (50% cumulative value of the number particle diameter distribution) of 0.5 μm or less and D90 (90% cumulative value of the number particle diameter distribution) of 1 μm or less. If the particle diameter of a colloid increases, the stability of polymerization may be degraded to degrade the shelf stability of a toner.

The amount of the above described dispersion stabilizer to be used is preferably 0.1 to 20 parts by weight relative to 100 parts by weight of a polymerizable monomer. If the amount of the dispersion stabilizer is less than 0.1 part by weight, it may be difficult to achieve sufficient polymerization stability and polymerization aggregates may be easily produced. On the other hand, If the dispersion stabilizer is used in an amount exceeding 20 parts by weight, the particle diameter of a toner after polymerization may be too small, which may not be practical.

A molecular weight modifier is preferably used as one of additives during polymerization reaction. As the molecular weight modifier, there can be mentioned mercaptans such as t-dodecyl mercaptan, n-dodecyl mercaptan, n-octyl mercaptan and 2,2,4,6, 6-pentamethylheptane-4-thiol and the like. The molecular weight modifier may be added before or during polymerization reaction. The molecular weight modifier is used preferably 0.01 to 10 parts by weight, and more preferably 0.1 to 5 parts by weight, per 100 parts byweight of the polymerizable monomer used.

The temperature for suspension polymerization is preferably 40° C. or higher, more preferably 50 to 90° C. The reaction time is preferably 1 to 20 hours, more preferably 2 to 10 hours. After the completion of polymerization, it is preferable to perform washing with acid or alkali in order to remove a dispersion stabilizer, filtrate toner particles, repeat washing and dehydration several times if necessary, and then dry the resultant toner particles, according to a conventional method.

The toner of the present invention can be used, as it is, for development in electrophotography. Generally, however, it is preferrable that the toner is used after a fine particles having a smaller particle diameter than that of the toner particles (the fine particles will be referred to hereinafter as an external additive) are adhered to or buried into the surfaces of the toner particles, in order to adjust the charging properties, flowability and shelf stability of the toner.

Examples of the external additives are inorganic particles and organic resin particles and the like. Specific examples of the inorganic particles include silicon dioxide, aluminum oxide, titanium oxide, zinc oxide, tinoxide, bariumtitanate, strontiumtitanateand the like. Specific examples of the organic resin particles include methacrylic ester polymer particles, acrylic ester polymer particles, styrene-methacrylic ester copolymer particles, styrene-acrylic ester copolymer particles, zinc stearate, calcium stearate, core-shell structure particles having a core formed of a styrene polymer and a shell formed of a methacrylic ester copolymer and the like. In the case of a magnetic-one-component developer, it may contain iron, cobalt, nickel or alloys mainly composed of these metals, or oxides such as ferrites. Of these particles, inorganic oxide particles, particularly silicon dioxide particles, are preferred. Moreover, these fine particles having their surface hydrophobicitizing-treated are preferred. Silicon dioxide particles having their surface hydrophobicitizing-treated are especially preferred. The amount of external additives is not particularly limited, but it is preferably 0.1 to 6 parts by weight per 100 parts by weight of toner particles. External additives may be used in combination of two or more. When external additives are used in combination, a method is preferred in which inorganic particles with different average particle diameters, or inorganic particles and organic particles, are used in combination. Deposition of external additives to the above described toner particles is achieved typically by charging the external additives and the toner particles in a mixer such as a Henschel mixer and stirring the mixture. Further, when a toner is prepared by the above described polymerization in water, a wet process may be used in which, for example, an external additive dispersed in water is mixed and stirred with a water dispersion of toner particles, followed by spray drying the mixed dispersion.

### EXAMPLES

The present invention is hereinafter to be described more specifically by the following examples. Such examples, however, are not to be construed as limiting in any way the scope- of the present invention. All designations of “part” or “parts” and “%” used in the following examples mean part or parts by weight and wt. % unless expressly noted.

In the examples, the toner was evaluated by the following tests.

1. Toner Characteristics

(1) Particle Diameter of Toner

The volume average particle diameter (Dv) of toner particles and the particle diameter distribution (Dv/Dp) i.e., the ratio of the volume average particle diameter (Dv) to the number average particle diameter (Dp) , were measured by means of a particle diameter measuring device (“Multisizer”, manufactured by Beckman Coulter Inc.). The measurement by the Multisizer was conducted under the following conditions:

Aperture diameter: 100 μm;

Medium: Isothone II; and

Number of particles measured: 100,000 particles.

(2) Toner Shape

As for the shape of toner particles, a photograph of the toner particles was taken with a scanning electron microscope; the photograph was read with a Nexus 9000 image processing unit; and a value obtained by dividing the length by the breadth (rl/rs) of a toner was determined. Specifically, the number of toner particles subjected to the measurement was 100.

(3) Dispersibility of Pigment

An appropriate amount of a toner is placed on a slide-glass and a cover-glass is placed on top of the thus-placed toner. They were heated to 170° C. by using a hot-plate, thereby the toner was melted. Then, the melted toner was pressed by pressing the cover-glass. An area of the pressed toner is observed, which is 20 μm thick by a thickness meter (trade name: K-402B, manufactured by Anritsu Corporation). The number of colorant particles having a length of at least 0.2 μm in an area of 100 μm of the toner sheet was counted using a portion of the toner sheet having a thickness of 20 μm, which was evaluated in accordance with the following evaluation standard:

good: the number of pigment particles with a length of 0.2 μm or more present in 100 μm² is 20 or less;

fair: the number of pigment particles with a length of 0.2 μm or more present in 100 μm2 is in the range of more than 20 to 50; and

poor: the number of pigment particles with a length of 0.2 μm or more present in 100 μm2 is more than 50.

(4) Absorbance and Color Difference

A toner (0.2 g) was dispersed in 100 ml of THF. The toner dispersion was filtered through a filter with a pore size of 0.45 μm (GL Chromatodisc, nonaqueous, pore size: 0.45 μm, manufactured by Kurabo Industries Ltd. ) to remove insolubles and pigments with a large particle diameter. The dispersion from which insolubles and pigments with a large particle diameter are removed was transferred to a 1 cm thick cell for measuring transparency, and was subjected to the measurement of absorbance and chromaticity coordinates in the L*a*b* color system by means of a spectrophotometer (trade name: SE-2000, manufactured by Nippon Denshoku Industries, Co., Ltd.) The color difference ΔE between the dispersion and THF solvent was determined from the measured values according to the following equation:
ΔE*=((ΔL*2+(Δa*2+(Δb*)²)^{1/2}
(5) GPC Area Ratio

Gel permeation chromatography was performed in the following conditions. The area of a region where the molecular weight exceeds 2,000 (A) and the area of a region where the molecular weight is from 500 to 2,000 (B) were determined, in the peak detected at a wavelength of 410 nm or 540 nm by a UV detector, and A/(A+B) was calculated (hereinafter referred to as a GPC area ratio).

Measurement Conditions for the measurement are as follows:

Measuring Equipment:

Main body: HLC-8120GPC (manufactured by Tosoh Corporation),

UV/visible light detector: UV-8020 (manufactured by Tosoh Corporation),

Controller: SC-8020 (manufactured by Tosoh Corporation),

Solvent: THF 1 ml/min,

Column: LF-804 Shodex 2 pieces (manufactured by Showa Denko K. K.),

Conversion to polystyrene, RIdetection, UV/visible light detection.

(6) Shelf Stability

A toner was put in a sealable container. The container was sealed and then placed in a constant temperature water bath at a temperature of 55° C. for 8 hours. Then, it was taken out of the bath and transferred onto a 42-mesh sieve with extra care so as not to break the structure of the toner. The sieve was shaken for 30 seconds on a powder measuring equipment (trade name: Powder Tester, manufactured by Hosokawamicron Corporation) in which the intensity of the shaking was set at 4.5. Then, the weight of the toner remaining on the sieve was measured, and it was defined as the weight of the aggregated toner. The shelf stability of the toner (% by weight) was calculated from the weight of the aggregated toner and that of the sample. Incidentally, a toner having a smaller shelf stability of toner (% by weight) is a better one.

(7) PH of the Aqueous Extract Solution

A toner (6 g) was dispersed in 100 g of ion-exchanged water with a pH of about 7, and the dispersion was heated and boiled for 10 minutes, and then the pH of the dispersion (extract solution) was measured.

(8) Basicity of Filtrate

The dispersion used in (4) was titrated with a 0.01 N perchloric acid solution in methyl isobutyl ketone. The basicity of the filtrate was determined from the amount of the perchloric acid solution in methyl isobutyl ketone required for neutralization.

2. Evaluation of Image Quality

(1) Image Density

Printing paper was set in a commercially available non-magnetic-one-component developing type printer (trade name: Microline 3010c, manufactured by Oki Data Corporation). A toner was put in a developing device of the printer, and was left standing over a day and a night under the (N/N) environment of a temperature of 23° C. and a humidity of 50%. Then, printing was performed at a image density of 5%. After 10 sheets were printed, solid pattern was printed. The printed solid pattern was measured for image density using a color reflection densitometer (trade name: 404A, product of X-rite Inc.). Specifically, the amount of toner was 0.35 mg/cm².

(2) Environmental Durability and Stability

Printing paper was set in a commercially available non-magnetic-one-component developing type printer (trade name: Microline 3010C, product of Oki Data Corporation), and a toner was put in a developing device of the printer. The toner was left standing over a day and a night under the (L/L) environment of a temperature of 10° C. and a humidity of 20%, the (N/N) environment of a temperature of 23° C. and a humidity of 50%, or (H/H) environment of a temperature of 35° C. and a humidity of 80%. Then, printing was continuously performed at a image density of 5% from the beginning, and solid pattern was printed every 500 pieces of paper. The printed solid pattern was measured for image density using a color reflection densitometer (trade name: 404A, manufactured by X-rite Inc.). At the same time, after each solid pattern was printed, plain pattern was printed and the printing was suspended. The developed toner on the photoconductive member was stripped off and collected by sticking with an adhesive tape (trade name: Scotch Mending Tape 810-3-18, manufactured by Sumitomo 3M Limited). Then the adhesive tape was pealed to stick it on a new sheet of paper to measure “hue (B),” using a spectrophotometer (trade name: SE2000, manufactured by Nippon Denshoku Industries Co., Ltd.). As a control, an adhesive tape alone was attached on another new sheet of paper to measure “hue (A).” Fog value was calculated and denoted as a color difference ΔE* after hue values were expressed as a coordinate in an L*a*b* space. Number of sheets was counted that can be continuously printed while maintaining the quality of images in which the image density is 1.3 or more and the fog value is 1 or less. The test printing was terminated when the number of sheets reached 10,000. Incidentally, larger number of sheets that can be continuously printed while maintaining the above described image quality is evaluated to show better environmental durability and stability.

(3) Gloss

The solid pattern printing image which was used for measuring the image density in (1) was used for measuring gloss by means of a gloss meter (trade name: VGS-SENSOR, manufactured by Nippon Denshoku Industries Co., Ltd.) at an angle of incidence on the image of 75°.

(4) Cockle

A toner in an amount of 0.6 mg/cm² was fixed on paper of A4 size, and the level of the warpage at the end of the paper was observed. The paper that has a smaller level of warpage is evaluated to have better toner characteristics.

### Production Example 1

Production of a Negative Charge Control Resin Composition

A negative charge control resin (100 parts; weight average molecular weight: 20,000, glass transition temperature: 65° C.), obtained by polymerizing 82% of styrene, 11% of butyl acrylate and 7% of 2-acrylamide-2-methylpropanesufonic acid, was dispersed in 24 parts of methyl ethyl ketone and 6 parts of methanol, and they were mixed and kneaded by a roll with cooling. After the resulting mixture was winded on the roll, 100 parts of a yellow pigment (C.I. Pigment Yellow 180, manufactured by Clariant Int. , Ltd.) was gradually added, and they were mixed and kneaded for 1 hour, to manufacture a negative charge control resin composition. During this period, the clearance between the rolls was initially 1 mm, broadened gradually, to finally to 3 mm, and an organic solvent (a solvent mixture of methyl ethyl ketone/methanol=4/1) was added occationally according to mixing and kneading condition of the negative charge control resin composition.

Toluene was added to a portion of the negative charge control resin thus-obtained, to obtain 5% toluene solution of the negative charge control resin composition. Then, the thus-obtained solution was coated on a glass plate using a doctor blade having a thickness of 30 μm and dried. No particle having a length of at least 0.2 μm by observing the sheet by optical micrograph.

### Production Example 2

Production of a Negative Charge Control Resin Composition

A negative charge control resin composition was obtained in the same way as in Production Example 1, except that a yellow pigment was replaced with a cyan pigment (C.I. Pigment Blue 15:4; manufactured by Clariant Int. Ltd.)

Toluene was added to a portion of the negative charge control resin thus-obtained to obtain 5% toluene solution of the negative charge control resin composition. Then, the thus-obtained solution was coated on a glass plate using a doctor blade having a thickness of 30 μm and dried. No particle having a length of at least 0.2 μm by observing the sheet by optical micrograph.

### Production Example 3

Production of a Negative Charge Control Resin Composition

A negative charge control resin (100 parts; weight average molecular weight: 20,000, glass transition temperature: 65° C.), obtained by polymerizing 82% of styrene, 11% of butyl acrylate and 7% of 2-acrylamide-2-methylpropanesufonic acid, was dispersed in 24 parts of methyl ethyl ketone and 6 parts of methanol, and they were mixed and kneaded by a roll with cooling. After the resulting mixture was winded on the roll, 100 parts of (C.I. Pigment Red 122, manufactured by Clariant Int. , Ltd.) was gradually added, and 1 part of an ethanol solution of potassium ethoxide (a concentration of 50% by weight) was further added, and they were mixed and kneaded for 1 hour, to manufacture a negative charge control resin composition. During this period, the clearance between the rolls was initially 1 mm, broadened gradually, to finally to 3 mm, and an organic solvent (a solvent mixture of methyl ethyl ketone /methanol=4/1) was added occationally according to mixing and kneading condition of the negative charge control resin composition. Furthermore, 0.5 g of the negative charge control resin composition was collected, and 20 ml of water was added to the composition. The mixture was sufficiently shaken and served for measuring pH. The ethanol solution of potassium ethoxide (a concentration of 50% by weight) was added by a small amount until the pH reaches 7.

Toluene was added to a portion of the negative charge control resin thus-obtained to obtain 5% toluene solution of the negative charge control resin composition. Then, the thus-obtained solution was coated on a glass plate using a doctor blade having a thickness of 30 μm and dried. No particle having a length of at least 0.2 μm by observing the sheet by optical micrograph.

Further, a water dispersion prepared by dispersing 6 g of the pigment used in 100 ml of ion-exchanged water having a pH of 7 had a pH of 6.7.

### Example 1

An aqueous solution containing 6.9 parts of sodium hydroxide (alkali metal hydroxide) dissolved in 50 parts of ion-exchanged water was gradually added to an aqueous solution containing 9.8 parts of magnesium chloride (water-soluble polyvalent metallic salt) dissolved in 250 parts of ion-exchanged water, with stirring, to prepare a magnesium hydroxide colloidal dispersion (colloid of hardly water-soluble metal hydroxide). As for the particle distribution of the above described colloid produced, the number average particle diameter D50 (50% cumulative value of the number particle diameter distribution) and D90 (90% cumulative value of the number particle diameter distribution) of the droplets were determined by a particle size analyzer (trade name: SALD 2000A, product of Shimadzu Corporation). The measurement by the particle size analyzer was performed under the following conditions: refractive index=1.55-0.20i, ultrasonic irradiation time=5 minutes, and a 10% solution of salt as a dispersion medium during the measurement of droplets.

A polymerizable monomer composition for core comprising 90 parts of styrene, 9.5 parts of butyl acrylate, 0.5 part of glycidyl methacrylate, 0.3 part of divinylbenzene, and 0.25 part of a polymethylmethacrylate macromer (trade name: AA-6, manufactured by Toagosei Co. Ltd.) and 10 parts of a master batch that is a negative charge control resin composition obtained in Product Example 1, was dissolved/dispersed to obtain a solution, to which 3 parts of t-dodecyl mercaptan and 10 parts of dipentaerythritol hexamyristate were added, stirred and mixed to be uniformly dispersed therein to obtain a polymerizable monomer composition for core.

Separately, 2 parts of methyl methacrylate and 100 parts of water were subjected to finely-dispersing treatment using an ultrasonic emulsifier to obtain an aqueous dispersion of a polymerizable monomer for shell. The particle diameter of the droplets of the polymerizable monomer for shell was determined by a particle size analyzer (tradename: SALD2000A, manufactured by Shimadzu Corporation). D90 was found to be 1.6 μm.

The above polymerizable monomer composition for core was poured into the above colloidal dispersion of magnesium hydroxide, and the mixture was stirred until droplets became stable. After stabilization of the droplets, 6 parts of t-butyl peroxy-2-ethylhexanoate (trade name: Perbutyl 0, manufactured by NOF Corporation) was added. The resultant monomer mixture was stirred for 30 minutes at 15,000 rpm under high shearing force by means of Ebara Milder (trade name: MDN303V, manufactured by EBARA Corp.) to form finer droplets of the polymerizable monomer composition for core. The thus-prepared aqueous dispersion containing the droplets of the polymerizable monomer composition for core was provided into a reactor equipped with agitating blades. The polymerization reaction was initiate at 90° C. At the time the conversion of the monomer into a polymer reached almost 100%, a reaction product in the reactor was sampled to measure the particle diameter of a core. The core had a particle diameter of 7.3 μm. The above aqueous dispersion of the polymerizable monomer for shell and 0.2 part of a water-soluble polymerization initiator (trade name: VA-086, manufactured by Wako Pure Chemical Industries, Ltd.) (2,2′-azobis{2-methyl-N-(2-hydroxyethyl)-propion amide}) dissolved in 65 parts of distilled water were added to the reactor. After the polymerization reaction was continued for 4 hours, the reaction was stopped, to obtain an aqueous dispersion of core-shell structure toner particles having a pH of 9.5.

While stirring the aqueous dispersion of core-shell structure toner particles obtained above, the pH of the system was adjusted to 5 or lower, by adding sulfuric acid, for 10 minutes at 25° C. to refer as acid-washing. This dispersion was then dehydrated by filtration. Then, 500 parts of ion-exchanged water was added to form a slurry again and conduct washing with water. Then, the dehydration and water washing procedure was repeated several times. Thereafter, solid content was separated by filtration and dried with a dryer for 2 days and nights at 45° C., whereby a toner particles was obtained.

The dried toner particles was taken out for measurement. The results were that volume average particle diameter (Dv) was 7.3 μm, volume average particle diameter (Dv)/number average particle diameter (Dp) was 1.21, rl/rs was 1.1. Furthermore, the number of pigment particles with a length of 0.2 μm or more present in 100 μm² was counted, and the number of pigment particles with a length of 0.2 μm or more in 100 μm² was found to be 5 pieces.

To 100 parts of the toner particles obtained above, there was added 0.6 part of colloidal silica (RX-200, manufactured by Nihon Aerosil Co. Ltd.) subjected to a hydrophobicity-imparting treatment. They were mixed by means of a Henschel mixer to prepare a negatively charged toner. The thus obtained toner for developing the electrostatic image was evaluated in the above manner. The results are shown in Table 1.

### Example 2

A toner particles was obtained in the same way as in Example 1, except that a monomer composition comprising of 90 parts of styrene, 8 parts of butyl acrylate and 2 parts of glycidyl methacrylate was used as the polymerizable monomer composition for core.

Thus obtained toner particles had a volume average particle diameter (Dv) of 7.1 μm and a ratio of the volume average particle diameter (Dv)/number average particle diameter (Dp) of 1.19. Further, the toner particles had a ratio of rl/rs of 1.1. Furthermore, the number of pigment particles with a length of 0.2 μm or more present in 100 μm² was counted, and the number of pigment particles with a length of 0.2 μm or more in 100 μm² was found to be 5 pieces.

The resulting toner particles was subjected to the same procedure as in Example 1, whereby a toner were obtained. The properties of the resulting toner, the resulting image and so on were evaluated in the same manner as in Example 1. The results are shown in Table 1.

### Example 3

A toner particles was obtained in the same way as in Example 1, except that a monomer composition comprising of 90 parts of styrene, 6 parts of butyl acrylate and 4 parts of glycidyl methacrylate was used as the polymerizable monomer composition for core.

Thus obtained toner particles had a volume average particle diameter (Dv) of 7.4 μm and a ratio of the volume average particle diameter (Dv)/number average particle diameter (Dp) of 1.16. Further, the toner particles had a ratio of rl/rs of 1.1. Furthermore, the number of pigment particles with a length of 0.2 μm or more present in 100 μm² was counted, and the number of pigment particles with a length of 0.2 μm or more in 100 μm² was found to be 7 pieces.

The resulting toner particles was subjected to the same procedure as in Example 1, whereby a toner was obtained. The properties of the resulting toner, the resulting image and so on were evaluated in the same manner as in Example 1. The results are shown in Table 1.

### Example 4

A Toner particles was obtained in the same way as in Example 1, except that a monomer composition comprising of 90 parts of styrene, 9.5 parts of butyl acrylate and 0.5 parts of glycidyl allyl ether was used as the polymerizable monomer composition for core.

Thus obtained toner particles had a volume average particle diameter (Dv) of 7.2 μm and a ratio of the volume average particle diameter (Dv)/number average particle diameter (Dp) of 1.13. Further, the toner particles had a ratio of rl/rs of 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 6 pieces.

The resulting toner particles was subjected to the same procedureas in Example 1, where by a toner was obtained. The properties of the resulting toner, the resulting image and so on were evaluated in the same manner as in Example 1. The results are shown in Table 1.

### Comparative Example 1

A polymerizable monomer composition for core comprising of 90 parts of styrene and 10 parts of butyl acrylate, 5 parts of a negative charge control resin (weight average molecular weight: 20,000, glass transition temperature: 65° C.) prepared by polymerizing 82% of styrene, 11% of butyl acrylate and 7% of 2-acrylamide-2-methylpropane sulfonic acid, and the yellow pigment (C.I. Pigment Yellow 180; manufactured by Clariant Int. Ltd.) were dissolved/dispersed to obtain a solution, to which 3 parts of t-dodecyl mercaptan and 10 parts of dipentaerythritol hexamyristate were added, stirred and mixed to be uniformly dispersed therein to obtain a polymerizable monomer composition for core.

Separately, 2 parts of methyl methacrylate and 100 parts of water were subjected to finely-dispersing treatment using an ultrasonic emulsifier to obtain an aqueous dispersion of a polymerizable monomer for shell. The particle diameter of the droplets of the polymerizable monomer for shell was determined by a particle size analyzer (trade name: SALD 2000A, manufactured by Shimadzu Corporation). D90 was found to be 1.8 μm.

The above polymerizable monomer composition for core was poured into the colloidal dispersion of magnesium hydroxide used in Example 1 (weight of the colloid: 4.0 parts), and the mixture was stirred until droplets became stable. After stabilization of the droplets, 6 parts of t-butyl peroxy-2-ethylhexanoate (trade name: Perbutyl 0, manufactured by NOF Corporation) was added. The resultant monomer mixture was stirred for 30 minutes at 15,000 rpm under high shearing force by means of Ebara Milder (trade name: MDN303V, manufactured by EBARA Corp.) to form finer droplets of the polymerizable monomer composition for core. The thus-prepared aqueous dispersion containing the droplets of the polymerizable monomer composition for core was provided into a reactor equipped with agitating blades. The polymerization reaction was initiate at 90° C. At the time the conversion of the monomer into a polymer reached almost 100%, a reaction product in the reactor was sampled to measure the particle diameter of a core. The core had a particle diameter of 7.2 μm. The above aqueous dispersion of the polymerizable monomer for shell and 0.2 part of a water-soluble polymerization initiator (trade name: VA-08 6, manufactured by Wako Pure Chemical Industries, Ltd.) (2,2′-azobis(2-methyl-N-(2-hydroxyethyl)-propion amide}) dissolved in 65 parts of distilled water were added to the reactor. After the polymerization reaction was continued for 4 hours, the reaction was stopped, to obtain an aqueous dispersion of core-shell structure toner particles having a pH of 9.5.

While stirring the aqueous dispersion of core-shell structure toner particles obtained above, the pH of the system was adjusted to 5 or lower by adding sulfuric acid, for 10 minutes at 25° C. to refer. as acid-washing. This dispersion was then dehydrated by filtration. Then, 500 parts of ion-exchanged water was added to form a slurry again and conduct washing with water. Then, the dehydration and water washing procedure was repeated several times. Thereafter, solid content was separated by filtration and dried with a dryer for 2 days and nights at 45° C., whereby a toner particles was obtained.

The dried toner particles was taken out for measurement. The results were that volume average particle diameter (Dv) was 7.2 μm, volume average particle diameter (Dv)/number average particle diameter (Dp) was 1.29, rl/rs was 1.1. Furthermore, the number of pigment particles with a length of 0.2 μm or more present in 100 μm² was counted, and the number of pigment particles with a length of 0.2 μm or more in 100 μm was found to be 23 pieces.

The resulting toner particles were subjected to the same procedure as in Example 1, whereby a toner was obtained. The properties of the resulting toner, the resulting image and so on were evaluated in the same manner as in Example 1. The results are shown in Table 2.

### Comparative Example 2

A toner particles was obtained in the same way as in Example 1, except that a monomer composition comprising of 90 parts of styrene and 10 parts of butyl acrylate was used as the polymerizable monomer composition for core.

Thus obtained toner particles had a volume average particle diameter (Dv) of 7.3 μm and a ratio of the volume average particle diameter (Dv)/number average particle diameter (Dp) of 1.25. Further, the toner particles had a ratio of rl/rs of 1.2. Furthermore, the number of pigment particles with a length of 0.2 μm or more present in 100 μm² was counted, and the number of pigment particles with a length of 0.2 μm or more in 100 μm² was found to be 23 pieces.

The resulting toner particles was subjected to the same procedure as in Example 1, whereby a toner was obtained. The properties of the resulting toner, the resulting image and so on were evaluated in the same manner as in Example 1. The results are shown in Table 2.

### Comparative Example 3

A toner particles was obtained in the same way as in Comparative Example 1, except that a monomer composition comprising of 90 parts of styrene, 8 parts of butyl acrylate and 2 parts of an epoxy resin was used as the polymerizable monomer composition for core.

Thus obtained toner particles had a volume average particle diameter (Dv) of 7.2 μm and a ratio of the volume average particle diameter (Dv)/number average particle diameter (Dp) of 1.29. Further, the toner particles had a ratio of rl/rs of 1.2. Furthermore, the number of pigment particles with a length of 0.2 μm or more present in 100 μm² was counted, and the number of pigment particles with a length of 0.2 μm or more in 100 μm² was found to be 38 pieces.

The resulting toner particles was subjected to the same procedure as in Example 1, whereby a toner was obtained. The properties of the resulting toner, the resulting image and so on were evaluated in the same manner as in Example 1. The results are shown in Table 2.

TABLE 1

| Example | Example | Example | Example |
|---|---|---|---|
| 1 | 2 | 3 | 4 |

Toner properties

| Volume average | 7.3 | 7.1 | 7.4 | 7.2 |
|---|---|---|---|---|
| particle diameter | | | | |
| (μm) | | | | |
| Particle | 1.21 | 1.19 | 1.16 | 1.13 |
| diameter | | | | |
| distribution | | | | |
| Average | 1.1 | 1.1 | 1.1 | 1.1 |
| sphericity | | | | |
| Maximum | 410 | 410 | 410 | 410 |
| absorption | | | | |
| wavelength (nm) | | | | |
| Absorbance | 1.3 | 1.6 | 2.1 | 1.5 |
| Color difference | 37 | 46 | 78 | 50 |
| GPC area ratio | 0.63 | 0.75 | 0.84 | 0.35 |
| Dispersibility of | good | good | good | good |
| pigment | (5 pieces) | (5 pieces) | (7 pieces) | (6 pieces) |
| Shelf stability | 0.2 | 0.2 | 0.3 | 0.3 |
| Evaluation of | | | | |
| image quality | | | | |
| Image density | 1.41 | 1.51 | 1.56 | 1.47 |
| Environmental | | | | |
| durability and | | | | |
| stability | | | | |
| L/L environment | 10,000 or | 10,000 or | 10,000 or | 10,000 or |
| | more | more | more | more |
| N/N environment | 10,000 or | 10,000 or | 10,000 or | 10,000 or |
| | more | more | more | more |
| H/H environment | 10,000 or | 10,000 or | 9,000 | 10,000 or |
| | more | more | | more |
| Gloss | 60 | 63 | 64 | 60 |
| Cockle | 1.3 | 1.3 | 1.5 | 1.0 |

TABLE 2

| | | |
|---|---|---|
| Comparative | Comparative | Comparative |
| Example 1 | Example 2 | Example 3 |

Toner properties

| Volume average | 7.2 | 7.3 | 7.2 |
|---|---|---|---|
| particle diameter | | | |
| (μm) | | | |
| Particle diameter | 1.29 | 1.25 | 1.29 |
| distribution | | | |
| Average sphericity | 1.1 | 1.2 | 1.2 |
| Maximum absorption | 410 | 410 | 410 |
| wavelength (nm) | | | |
| Absorbance | 0.1 | 0.1 | 0.1 |
| Color difference | 0.3 | 3 | 5 |
| GPC area ratio | 0.05 | 0.05 | 0.15 |
| Dispersibility of | poor | fair | fair |
| pigment | (51 pieces) | (23 pieces) | (38 pieces) |
| Shelf stability | 0.4 | 0.4 | 4.8 |
| Evaluation of image | | | |
| quality | | | |
| Image density | 0.86 | 1.04 | 1.12 |
| Environmental | | | |
| durability and | | | |
| stability | | | |
| L/L environment | 10,000 or | 10,000 or | 4,500 |
| | more | more | |
| N/N environment | 10,000 or | 10,000 or | 4,000 |
| | more | more | |
| H/H environment | 10,000 or | 10,000 or | 3,000 |
| | more | more | |
| Gloss | 56 | 40 | 13 |
| Cockle | 1.3 | 1.3 | 1.2 |

As it can be seen from Tables 1 and 2, the toners in Examples 1 to 4 have better dispersibility of the pigment than those in Comparative Examples 1 to 3. In addition the toners in Examples 1 to 4 are evaluated to be superior in toner properties and image quality to those in Comparative Examples 1 to 3.

### Comparative Example 4

The toner obtained in Comparative Example 2 was used to evaluate image density and cockle, wherein the amount of toner to be used per unit area was doubled. The image density was 1.59, and in the evaluation of cockle, the level of the warpage at the end of the paper was 2.5 cm.

### Example 5

An aqueous solution containing 6.9 parts of sodium hydroxide (alkali metal hydroxide) dissolved in 50 parts of ion-exchanged water was gradually added to an aqueous solution containing 9.8 parts of magnesium chloride (water-soluble polyvalent metallic salt) dissolved in 250 parts of ion-exchanged water, with stirring, to prepare a magnesium hydroxide colloidal dispersion (colloid of hardly water-soluble metal hydroxide). As for the particle distribution of the above described colloid produced, the number average particle diameter D50 (50% cumulative value of the number particle diameter distribution) and D90 (90% cumulative value of the number particle diameter distribution) of the droplets were determined by a particle size analyzer (trade name: SALD 2000A, product of Shimadzu Corporation). The measurement by the particle size analyzer was performed under the following conditions: refractive index=1.55-0.20i, ultrasonic irradiation time=5 minutes, and a 10% solution of salt as a dispersion medium during the measurement of droplets.

A polymerizable monomer composition for core comprising 90 parts of styrene, 9.875 parts of butyl acrylate, 0.25 part of glycidyl methacrylate and 10 parts of a master batch that is a negative charge control resin composition obtained in Product Example 2, was dissolved/dispersed to obtain a solution, to which 3 parts of t-dodecyl mercaptan and 10 parts of dipentaerythritol hexamyristate were added, stirred and mixed to be uniformly dispersed therein to obtain a polymerizable monomer composition for core.

Separately, 2 parts of methyl methacrylate and 100 parts of water were subjected to finely-dispersing treatment using an ultrasonic emulsifier to obtain an aqueous dispersion of a polymerizable monomer for shell. The particle diameter of the droplets of the polymerizable monomer for shell was determined by a particle size analyzer (trade name: SALD2000A, manufactured by Shimadzu Corporation). D90 was found to be 1.7 μm.

The above polymerizable monomer composition for core was poured into the above colloidal dispersion of magnesium hydroxide (weight of the colloid: 4.0 parts), and the mixture was stirred until droplets became stable. After stabilization of the droplets, 6 parts of t-butyl peroxy-2-ethylhexanoate (trade name: Perbutyl O, manufactured by NOF Corporation) was added. The resultant monomer mixture was stirred for 30 minutes at 15,000 rpm under high shearing force by means of Ebara Milder (trade name: MDN303V, manufactured by EBARA Corp.) to form finer droplets of the polymerizable monomer composition for core. The thus-prepared aqueous dispersion containing the droplets of the polymerizable monomer composition for core was provided into a reactor equipped with agitating blades. The polymerization reaction was initiate at 90° C. At the time the conversion of the monomer into a polymer reached almost 100%, a reaction product in the reactor was sampled to measure the particle diameter of a core. The core had a particle diameter of 7.3 μm. The above aqueous dispersion of the polymerizable monomer for shell and 0.2 part of a water-soluble polymerization initiator (trade name: VA-086, manufactured by Wako Pure Chemical Industries, Ltd.) (2,2′-azobis(2-methyl-N-(2-hydroxyethyl)-propion amide}) dissolved in 65 parts of distilled water were added to the reactor. After the polymerization reaction was continued for 4 hours, the reaction was stopped, to obtain an aqueous dispersion of core-shell structure toner particles having a pH of 9.5.

While stirring the aqueous dispersion of core-shell structure toner particles obtained above, the pH of the system was adjusted to 5 or lower by adding sulfuric acid, for 10 minutes at 25° C. to refer as acid-washing. This dispersion was then dehydrated by filtration. Then, 500 parts of ion-exchanged water was added to form a slurry again and conduct washing with water. Then, the dehydration and water washing procedure was repeated several times. Thereafter, solid content was separated by filtration and dried with a dryer for 2 days and nights at 45° C., whereby a toner particles was obtained.

The dried toner particles were taken out for measurement. The results were that volume average particle diameter (Dv) was 7.5 μm, volume average particle diameter (Dv)/number average particle diameter (Dp) was 1.24, rl/rs was 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 7 pieces.

To 100 parts of the toner particles obtained above, there was added 0.6 part of colloidal silica (RX-200, manufactured by Nihon Aerosil Co. Ltd.) subjected to a hydrophobicity-imparting treatment. They were mixed by means of a Henschel mixer to prepare a negatively charged toner. The thus obtained toner for developing the electrostatic image was evaluated in the above manner. The results are shown in Table 3.

### Example 6

A toner particles was obtained in the same way as in Example 5, except that a monomer composition comprising of 90 parts of styrene, 9.5 parts of butyl acrylate and 0.5 parts of glycidyl methacrylate was used as the polymerizable monomer composition for core.

Thus obtained toner particles had a volume average particle diameter (Dv) of 7.8 μm and a ratio of the volume average particle diameter (Dv)/number average particle diameter (Dp) of 1.28. Further, the toner particles had a ratio of rl/rs of 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 5 pieces.

The resulting toner particles was subjected to the same procedure as in Example 5, whereby a toner was obtained. The properties of the resulting toner, the resulting image and so on were evaluated in the same manner as in Example 1. The results are shown in Table 3.

### Example 7

A toner particles was obtained in the same way as in Example 5, except that a monomer composition comprising of 90 parts of styrene, 9.5 parts of butyl acrylate and 0.5 parts of methacryloyl chloride was used as the polymerizable monomer composition for core.

Thus obtained toner particles had a volume average particle diameter (Dv) of 7.7 μm and a ratio of the volume average particle diameter (Dv)/number average particle diameter (Dp) of 1.32. Further, the toner particles had a ratio of rl/rs of 1.2, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 8 pieces.

The resulting toner particles was subjected to the same procedure as in Example 5, whereby a toner was obtained. The properties of the resulting toner, the resulting image and so on were evaluated in the same manner as in Example 5. The results are shown in Table 3.

### Example 8

A toner particles was obtained in the same way as in Example 5, except that a monomer composition comprising of 90 parts of styrene, 8 parts of butyl acrylate and 2 parts of glycidyl methacrylate was used as the polymerizable monomer composition for core.

Thus obtained toner particles had a volume average particle diameter (Dv) of 7.8 μm and a ratio of the volume average particle diameter (Dv)/number average particle diameter (Dp) of 1.39. Further, the toner particles had a ratio of rl/rs of 1.2, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 3 pieces.

The resulting toner particles was subjected to the same procedure as in Example 5, whereby a toner was obtained. The properties of the resulting toner, the resulting image and so on were evaluated in the same manner as in Example 5. The results are shown in Table 3.

### Comparative Example 5

A polymerizable monomer composition for core comprising of 90 parts of styrene and 10 parts of butyl acrylate, 5 parts of a negative charge control resin (weight average molecular weight: 20,000, glass transition temperature: 65° C.) prepared by polymerizing 82% of styrene, 11% of butyl acrylate and 7% of 2-acrylamide-2-methylpropane sulfonic acid, and 5 parts of the cyan pigment (C.I. Pigment Blue 15:4; manufactured by Clariant Int. Ltd.) were dissolved/dispersed to obtain a solution, to which 3 parts of t-dodecyl mercaptan and 10 parts of dipentaerythritol hexamyristate were added, stirred and mixed to be uniformly dispersed therein to obtain a polymerizable monomer composition for core.

Separately, 2 parts of methyl methacrylate and 100 parts of water were subjected to finely-dispersing treatment using an ultrasonic emulsifier to obtain an aqueous dispersion of a polymerizable monomer for shell. The particle diameter of the droplets of the polymerizable monomer for shell was determined by a particle size analyzer (tradename: SALD2000A, manufactured by Shimadzu Corporation). D90 was found to be 1.9 μm.

The above polymerizable monomer composition for core was poured into the colloidal dispersion of magnesium hydroxide used in Example 5 (weight of the colloid: 4.0 parts), and the mixture was stirred until droplets became stable. After stabilization of the droplets, 6 parts of t-butyl peroxy-2-ethylhexanoate (trade name: Perbutyl 0, manufactured by NOF Corporation) was added. The resultant monomer mixture was stirred for 30 minutes at 15,000 rpm under high shearing force by means of Ebara Milder (trade name: MDN303V, manufactured by EBARA Corp.) to form finer droplets of the polymerizable monomer composition for core. The thus-prepared aqueous dispersion containing the droplets of the polymerizable monomer composition for core was provided into a reactor equipped with agitating blades. The polymerization reaction was initiate at 90° C. At the time the conversion of the monomer into a polymer reached almost 100%, a reaction product in the reactor was sampled to measure the particle diameter of a core. The core had a particle diameter of 7.4 μm. The above aqueous dispersion of the polymerizable monomer for shell and 0.2 part of a water-soluble polymerization initiator (trade name: VA-086, manufactured by Wako Pure Chemical Industries, Ltd.)(2,2′-azobis{2-methyl-N-(2-hydroxyethyl)-propion amide}) dissolved in 65 parts of distilled water were added to the reactor. After the polymerization reaction was continued for 4 hours, the reaction was stopped, to obtain an aqueous dispersion of core-shell structure toner particles having a pH of 9.5.

While stirring the aqueous dispersion of core-shell structure toner particles obtained above, the pH of the system was adjusted to 5 or lower by adding sulfuric acid, for 10 minutes at 25° C. to refer as acid-washing. This dispersion was then dehydrated by filtration. Then, 500 parts of ion-exchanged water was added to form a slurry again and conduct washing with water. Then, the dehydration and water washing procedure was repeated several times. Thereafter, solid content was separated by filtration and dried with a dryer for 2 days and nights at 45° C., whereby a toner particles was obtained.

The dried toner particles was taken out for measurement. The results were that volume average particle diameter (Dv) was 7.5 μm, volume average particle diameter (Dv)/number average particle diameter (Dp) was 1.19, rl/rs was 1.2, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 51 pieces.

The resulting toner particles was subjected to the same procedure as in Example 5, whereby a toner was obtained. The properties of the resulting toner, the resulting image and so on were evaluated in the same manner as in Example 5. The results are shown in Table 4.

### Comparative Example 6

A toner particles was obtained in the same way as in Example 5, except that a monomer composition comprising of 90 parts of styrene, 8 parts of butyl acrylate and 2 parts of glycidyl methacrylate was used as the polymerizable monomer composition for core, and the charge control resin was replaced by 0.5 part of aluminum salicylate.

Thus obtained toner particles had a volume average particle diameter (Dv) of 7.6 μm and a ratio of the volume average particle diameter (Dv)/number average particle diameter (Dp) of 1.30. Further, the toner particles had a ratio of rl/rs of 1.2, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 31 pieces.

The resulting toner particles was subjected to the same procedure as in Example 5, whereby a toner was obtained. The properties of the resulting toner, the resulting image and so on were evaluated in the same manner as in Example 5. The results are shown in Table 4.

TABLE 3

| Example | Example | Example | Example |
|---|---|---|---|
| 5 | 6 | 7 | 8 |

Toner properties

| Volume average | 7.5 | 7.8 | 7.7 | 7.8 |
|---|---|---|---|---|
| particle diameter | | | | |
| (μm) | | | | |
| Particle | 1.24 | 1.28 | 1.32 | 1.39 |
| diameter | | | | |
| distribution | | | | |
| Average | 1.1 | 1.1 | 1.2 | 1.2 |
| sphericity | | | | |
| Maximum | 660 | 660 | 660 | 660 |
| absorption | | | | |
| wavelength (nm) | | | | |
| Absorbance | 0.62 | 0.86 | 0.94 | 1.47 |
| Color | 30 | 43 | 42 | 68 |
| difference | | | | |
| pH of aqueous | 5.8 | 6.2 | 5.9 | 6.0 |
| extract | | | | |
| solution | | | | |
| Dispersibility | good | good | good | good |
| of pigment | (7 pieces) | (5 pieces) | (8 pieces) | (3 pieces) |
| Shelf stability | 0.1 | 0.3 | 0.2 | 0.2 |
| Evaluation of | | | | |
| image quality | | | | |
| Image density | 1.35 | 1.44 | 1.50 | 1.65 |
| Environmental | | | | |
| durability and | | | | |
| stability | | | | |
| L/L environment | 10,000 or | 10,000 or | 10,000 or | 10,000 or |
| | more | more | more | more |
| N/N environment | 10,000 or | 10,000 or | 10,000 or | 10,000 or |
| | more | more | more | more |
| H/H environment | 10,000 or | 10,000 or | 10,000 or | 10,000 or |
| | more | more | more | more |
| Gloss | 58 | 60 | 61 | 63 |
| Cockle | 1.5 | 1.4 | 1.4 | 1.3 |

TABLE 4

| | Comparative | Comparative |
|---|---|---|
| | Example 5 | Example 6 |
| Toner properties | | |
| Volume average | 7.5 | 7.6 |
| particle diameter | | |
| (μm) | | |
| Particle diameter | 1.19 | 1.30 |
| distribution | | |
| Average sphericity | 1.2 | 1.1 |
| Maximum absorption | 660 | 660 |
| wavelength (nm) | | |
| Absorbance | 0.03 | 0.10 |
| Color difference | 0.2 | 4.0 |
| pH of aqueous | 6.5 | 6.8 |
| extract solution | | |
| Dispersibility of | poor | fair |
| pigment | (51 pieces) | (31 pieces) |
| Shelf stability | 0.2 | 4 |
| Evaluation of image | | |
| quality | | |
| Image density | 0.85 | 0.91 |
| Environmental | | |
| durability and | | |
| stability | | |
| L/L environment | 9,500 | 7,000 |
| N/N environment | 10,000 or | 5,500 |
| | more | |
| H/H environment | 9,000 | 4,000 |
| Gloss | 55 | 48 |
| Cockle | 1.6 | 1.3 |

As it can be seen from Tables 3 and 4, the toners in Examples 5 to 8 have better pigment dispersion than those in Comparative Examples 5 and 6. In addition, the toners in Examples 5 to 8 are evaluated to be superior in toner properties and image quality to those in Comparative Examples 5 and 6.

### Comparative Example 7

The toner obtained in Comparative Example 6 was used to evaluate image density and cockle, wherein the amount of toner to be used per unit area was doubled. The image density was 1.51, and in the evaluation of cockle, the level of the warpage at the end of the paper was 2.8 cm.

### Example 9

An aqueous solution containing 6.9 parts of sodium hydroxide (alkali metal hydroxide) dissolved in 50 parts of ion-exchanged water was gradually added to an aqueous solution containing 9.8 parts of magnesium chloride (water-soluble polyvalent metallic salt) dissolved in 250 parts of ion-exchanged water, with stirring, to prepare a magnesium hydroxide colloidal dispersion (colloid of hardly water-soluble metal hydroxide). As for the particle distribution of the above described colloid produced, the number average particle diameter D50 (50% cumulative value of the number particle diameter distribution) and D90 (90% cumulative value of the number particle diameter distribution) of the droplets were determined by a particle size analyzer (trade name: SALD 2000A, product of Shimadzu Corporation). The measurement by the particle size analyzer was performed under the following conditions: refractive index=1.55-0.20i, ultrasonic irradiation time=5 minutes, and a 10% solution of salt as a dispersion medium during the measurement of droplets.

A polymerizable monomer composition for core comprising 90 parts of styrene, 9.875 parts of butyl acrylate, 0.125 partofglycidyl methacrylate and 10 parts of a master batch that is a negative charge control resin composition obtained in Product Example 3 was dissolved/dispersed to obtain a solution, to which 3 parts of t-dodecyl mercaptan and 10 parts of dipentaerythritol hexamyristate were added, stirred and mixed to be uniformly dispersed therein to obtain a polymerizable monomer composition for core.

Separately, 2 parts of methyl methacrylate and 100 parts of water were subjected to finely-dispersing treatment using an ultrasonic emulsifier to obtain an aqueous dispersion of a polymerizable monomer for shell. The particle diameter of the droplets of the polymerizable monomer for shell was determined by a particle size analyzer (trade name: SALD2000A, manufacturedby Shimadzu Corporation). D90 was found to be 1.6 μm.

The above polymerizablemonomer composition for core was poured into the above colloidal dispersion of magnesium hydroxide (weight of the colloid: 4.0 parts), and the mixture was stirred until droplets became stable. After stabilization of the droplets, 6 parts of t-butyl peroxy-2-ethylhexanoate (trade name: Perbutyl 0, manufactured by NOF Corporation) was added. The resultant monomer mixture was stirred for 30 minutes at 15,000 rpm under high shearing force by means of Ebara Milder (trade name: MDN303V, manufactured by EBARA Corp.) to form finer droplets of the polymerizable monomer composition for core. The thus-prepared aqueous dispersion containing the droplets of the polymerizable monomer composition for core was provided into a reactor equipped with agitating blades. The polymerization reaction was initiate at 90° C. At the time the conversion of the monomer into a polymer reached almost 100%, a reaction product in the reactor was sampled to measure the particle diameter of a core. The core had a particle diameter of 7.3 μm. The above aqueous dispersion of the polymerizable monomer for shell and 0.2 part of a water-soluble polymerization initiator (trade name: VA-086, manufactured by Wako Pure Chemical Industries, Ltd.) (2,2′-azobis{2-methyl-N-(2-hydroxyethyl)-propion amide}) dissolved in 65 parts of distilled water were added to the reactor. After the polymerization reaction was continued for 4 hours, the reaction was stopped, to obtain an aqueous dispersion of core-shell structure toner particles having a pH of 9.5.

While stirring the aqueous dispersion of core-shell structure toner particles obtained above, the pH of the system was adjusted to 5 or lower by adding sulfuric acid, for 10 minutes at 25° C. to refer as acid-washing. This dispersion was then dehydrated by filtration. Then, 500 parts of ion-exchanged water was added to form a slurry again and conduct washing with water. Then, the dehydration and water washing procedure was repeated several times. Thereafter, solid content was separated by filtration and dried with a dryer for 2 days and nights at 45° C., whereby toner particles were obtained.

The dried toner particles were taken out for measurement. The results were that volume average particle diameter (Dv) was 7.5 μm, volume average particle diameter (Dv)/number average particle diameter (Dp) was 1.19, rl/rs was 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 20 pieces.

To 100 parts of the toner particles obtained above, there was added 0.6 part of colloidal silica (RX-200, manufactured by Nihon Aerosil Co. Ltd.) subjected to a hydrophobicity-imparting treatment. They were mixed by means of a Henschel mixer to prepare a negatively charged toner. The thus obtained toner for developing the electrostatic image was evaluated in the above manner. The results are shown in Table 5.

### Example 10

A toner particles was obtained in the same way as in Example 9, except that a monomer composition comprising of 90 parts of styrene, 9.5 parts of butyl acrylate and 0.5 parts of glycidyl methacrylate was used as the polymerizable monomer composition for core.

Thus obtained toner particles had a volume average particle diameter (Dv) of 7.4 μm and a ratio of the volume average particle diameter (Dv)/number average particle diameter (Dp) of 1.31. Further, the toner particles had a ratio of rl/rs of 1.2, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 13 pieces.

The resulting toner particles was subjected to the same procedure as in Example 9, whereby a toner was obtained. The properties of the resulting toner, the resulting image and so on were evaluated in the same manner as in Example 9. The results are shown in Table 5.

### Example 11

A toner particles was obtained in the same way as in Example 9, except that a polymerizable monomer composition comprising of 90 parts of styrene, 9 parts of butyl acrylate and 2 parts of glycidyl methacrylate was used as the polymerizable monomer composition for core.

Thus obtained toner particles had a volume average particle diameter (Dv) of 7.3 μm and a ratio of the volume average particle diameter (Dv)/number average particle diameter (Dp) of 1.26. Further, the toner particles had a ratio of rl/rs of 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 13 pieces.

The resulting toner particles was subjected to the same procedure as in Example 9, whereby a toner was obtained. The properties of the resulting toner, the resulting image and so on were evaluated in the same manner as in Example 9. The results are shown in Table 5.

### Example 12

A toner particles was obtained in the same way as in Example 9, except that a monomer composition comprising of 90 parts of styrene, 6 parts of butyl acrylate and 4 parts of methacryloyl chloride was used as the polymerizable monomer composition for core.

Thus obtained toner particles had a volume average particle diameter (Dv) of 7.8 μm and a ratio of the volume average particle diameter (Dv)/number average particle diameter (Dp) of 1.42. Further, the toner particles had a ratio of rl/rs of 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 12 pieces.

The resulting toner particles was subjected to the same procedure as in Example 9, whereby a toner was obtained. The properties of the resulting toner, the resulting image and so on were evaluated in the same manner as in Example 9. The results are shown in Table 5.

### Example 13

A toner particles was obtained in the same way as in Example 9, except that a monomer composition comprising of 90 parts of styrene, 9.5 parts of butyl acrylate and 0.5 parts of glycidyl allyl was used as the polymerizable monomer composition for core, and C.I. Pigment Red 209 was used as the pigment. Further, a water dispersion prepared by dispersing 6 g of the pigment used in 100 ml of ion-exchanged water having a pH of 7 had a pH of 5.9.

Thus obtained toner particles had a volume average particle diameter (Dv) of 7.9 μm and a ratio of the volume average particle diameter (Dv)/number average particle diameter (Dp) of 1.36. Further, the toner particles had a ratio of rl/rs of 1.2, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 10 pieces.

The resulting toner particles was subjected to the same procedure as in Example 9, whereby a toner was obtained. The properties of the resulting toner, the resulting image and so on were evaluated in the same manner as in Example 9. The results are shown in Table 6.

### Example 14

A toner particles was obtained in the same manner as in Example 9 except that a monomer composition comprising 90 parts of styrene, 9.75 parts of butyl acrylate and 0.25 part of ethyleneglycol diglycidyl ether was used as a polymerizable monomer composition for core, and C.I. Pigment Red 57.1 was used as a pigment. A water dispersion prepared by dispersing 6 g of the pigment used in 100 ml of ion-exchanged water having a pH of 7.0 had a pH of 6.2.

Thus obtained toner particles had a volume average particle diameter (Dv) of 6.9 μm and a ratio of the volume average particle diameter (Dv)/number average particle diameter (Dp) of 1.26. Further, the toner particles had a ratio of rl/rs of 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 9 pieces.

Further, the obtained toner particles was treated in the same manner as in Example 9 to obtain a toner. The obtained toner was characterized and evaluated for images in the same manner as in Example 9. The results are shown in Table 6.

### Comparative Example 8

A polymerizable monomer composition for core comprising of 90 parts of styrene and 9 parts of butyl acrylate, 2 parts of an epoxy resin, 0.55 part of aluminum salicylate as a charge control agent and 5 parts of a cyan pigment (C.I. Pigment Red 122; manufactured by Clariant Int. Ltd.) were dissolved/dispersed to obtain a solution, to which 3 parts of t-dodecyl mercaptan and 10 parts of dipentaerythritol hexamyristate were added, stirred and mixed to be uniformly dispersed therein to obtain a polymerizable monomer composition for core.

Separately, 2 parts of methyl methacrylate and 100 parts of water were subjected to finely-dispersing treatment using an ultrasonic emulsifier to obtain an aqueous dispersion of a polymerizable monomer for shell. The particle diameter of the droplets of the polymerizable monomer for shell was determined by a particle size analyzer (trade name: SALD 2000A, manufactured by Shimadzu Corporation). D90 was found to be 1.8 μm.

The above polymerizable monomer composition for core was poured into the colloidal dispersion of magnesium hydroxide used in Example 9 (weight of the colloid: 4.0 parts), and the mixture was stirred until droplets became stable. After stabilization of the droplets, 6 parts of t-butyl peroxy-2-ethylhexanoate (trade name: Perbutyl 0, manufactured by NOF Corporation) was added. The resultant monomer mixture was stirred for 30 minutes at 15,000 rpm under high shearing force by means of Ebara Milder (trade name: MDN303V, manufactured by EBARA Corp.) to form finer droplets of the polymerizable monomer composition for core. The thus-prepared aqueous dispersion containing the droplets of the polymerizable monomer composition for core was provided into a reactor equipped with agitating blades. The polymerization reaction was initiate at 90° C. At the time the conversion of the monomer into a polymer reached almost 100%, a reaction product in the reactor was sampled to measure the particle diameter of a core. The core had a particle diameter of 7.3 μm. The above aqueous dispersion of the polymerizable monomer for shell and 0.2 part of a water-soluble polymerization initiator (trade name: VA-086, manufactured by Wako Pure Chemical Industries, Ltd.) (2,2′-azobis{2-methyl-N-(2-hydroxyethyl)-propion amide) ) dissolved in 65 parts of distilled water were added to the reactor. After the polymerization reaction was continued for 4 hours, the reaction was stopped, to obtain an aqueous dispersion of core-shell structure toner particles having a pH of 9.5.

While stirring the aqueous dispersion of core-shell structure toner particles obtained above, the pH of the system was adjusted to 5 or lower, by adding sulfuric acid, for 10 minutes at 25° C. to refer as acid-washing. This dispersion was then dehydrated by filtration. Then, 500 parts of ion-exchanged water was added to form a slurry again and conduct washing with water. Then, the dehydration and water washing procedure was repeated several times. Thereafter, solid content was separated by filtration and dried with a dryer for 2 days and nights at 45° C., whereby a toner particles was obtained.

The dried toner particles was taken out for measurement. The results were that volume average particle diameter (Dv) was 7.3 μm, volume average particle diameter (Dv)/number average particle diameter (Dp) was 1.24, rl/rs was 1.1, and had a tetrahydrofuran-insoluble content of 0%. Furthermore, the number of pigment particles with a length of 0.2 μm or more present in 100 μm²was counted, and the number of pigment particles with a length of 0.2 μm or more in 100 μm² was found to be 24 pieces.

The resulting toner particles was subjected to the same procedure as in Example 9, whereby a toner was obtained. The properties of the resulting toner, the resulting image and so on were evaluated in the same manner as in Example 9. The results are shown in Table 7.

### Comparative Example 9

A toner particles was obtained in the same manner as in Example 9 except that a monomer composition comprising 90 parts of styrene and 10 parts of butyl acrylate was used as a polymerizable monomer composition for the core.

Thus obtained toner particles had a volume average particle diameter (Dv) of 7.2 μm and a ratio of the volume average particle diameter (Dv)/number average particle diameter (Dp) of 1.28. Further, the toner particles had a ratio of rl/rs of 1.1, and had a tetrahydrofuran-insoluble content of 0%. Furthermore, the number of pigment particles with a length of 0.2 μm or more present in 100 μm² was counted, and the number of pigment particles with a length of 0.2 μm or more in 100 μm² was found to be 24 pieces.

Further, the obtained toner particles was treated in the same manner as in Example 9 to obtain a toner. The obtained toner was characterized and evaluated for images in the same manner as in Example 9. The results are shown in Table 7.

TABLE 5

| Example | Example | Example | Example |
|---|---|---|---|
| 9 | 10 | 11 | 12 |

Toner properties

| Volume average | 7.5 | 7.4 | 7.3 | 7.8 |
|---|---|---|---|---|
| particle diameter | | | | |
| (μm) | | | | |
| Particle | 1.19 | 1.31 | 1.26 | 1.42 |
| diameter | | | | |
| distribution | | | | |
| Average sphericity | 1.1 | 1.2 | 1.1 | 1.1 |
| Maximum | 540 | 540 | 540 | 540 |
| absorption | | | | |
| wavelength (nm) | | | | |
| Absorbance | 0.23 | 0.73 | 1.63 | 1.89 |
| Color | 6 | 12 | 28 | 38 |
| difference | | | | |
| GPC area ratio | 0.12 | 0.28 | 0.76 | 0.77 |
| Basicity | 4.3 | 6.2 | 3.2 | 4.5 |
| (mmol/g) | | | | |
| Dispersibility | fair | good | good | good |
| of pigment | (20 | (13 | (13 | (12 |
| | pieces) | pieces) | pieces) | pieces) |
| Shelf stability | 0.3 | 0.3 | 1.0 | 1.8 |
| Evaluation of | | | | |
| image quality | | | | |
| Image density | 1.24 | 1.46 | 1.51 | 1.56 |
| Environmental | | | | |
| durability and | | | | |
| stability | | | | |
| L/L environment | 10,000 or | 10,000 or | 10,000 or | 10,000 or |
| | more | more | more | more |
| N/N environment | 10,000 or | 10,000 or | 10,000 or | 10,000 or |
| | more | more | more | more |
| H/H environment | 10,000 or | 10,000 or | 10,000 or | 9,500 |
| | more | more | more | |
| Gloss | 58 | 60 | 62 | 61 |
| Cockle | 1.2 | 1.2 | 1.4 | 1.5 |

TABLE 6

| | Example | Example |
|---|---|---|
| | 13 | 14 |
| Toner properties | | |
| Volume average | 7.9 | 6.9 |
| particle diameter | | |
| (μm) | | |
| Particle diameter | 1.36 | 1.26 |
| distribution | | |
| Average sphericity | 1.2 | 1.1 |
| Maximum absorption | 540 | 540 |
| wavelength (nm) | | |
| Absorbance | 0.78 | 0.49 |
| Color difference | 10 | 8 |
| GPC area ratio | 0.38 | 0.21 |
| Basicity (mmol/g) | 0.3 | 0.2 |
| Dispersibility of | good | good |
| pigment | (10 pieces) | (9 pieces) |
| Shelf stability | 0.7 | 0.2 |
| Evaluation of image | | |
| quality | | |
| Image density | 1.48 | 1.38 |
| Environmental | | |
| durability and | | |
| stability | | |
| L/L environment | 10,000 or | 10,000 or |
| | more | more |
| N/N environment | 10,000 or | 10,000 or |
| | more | more |
| H/H environment | 10,000 or | 10,000 or |
| | more | more |
| Gloss | 57 | 56 |
| Cockle | 1.8 | 1.3 |

TABLE 7

| | Comparative | Comparative |
|---|---|---|
| | Example 8 | Example 9 |
| Toner properties | | |
| Volume average | 7.3 | 7.2 |
| particle diameter | | |
| (μm) | | |
| Particle diameter | 1.24 | 1.28 |
| distribution | | |
| Average sphericity | 1.1 | 1.1 |
| Maximum absorption | 540 | 540 |
| wavelength (nm) | | |
| Absorbance | 0.12 | 0.12 |
| Color difference | 8 | 0.2 |
| GPC area ratio | 0.04 | 0.04 |
| Basicity (mmol/g) | 0.8 | 1.0 |
| Dispersibility of | fair | fair |
| pigment | (24 pieces) | (24 pieces) |
| Shelf stability | 4.4 | 0.3 |
| Evaluation of image | | |
| quality | | |
| Image density | 0.81 | 0.72 |
| Environmental | | |
| durability and | | |
| stability | | |
| L/L environment | 6,500 | 10,000 or |
| | | more |
| N/N environment | 4,000 | 10,000 or |
| | | more |
| H/H environment | 3,500 | 10,000 or |
| | | more |
| Gloss | 49 | 55 |
| Cockle | 1.2 | 1.3 |

As it can be seen from Tables 5, 6 and 7, the toners in Examples 9 to 14 have better dispersibility of the pigment than those in Comparative Examples 8 and 9. In addition, the toners in Examples 9 to 14 are evaluated to be superior in toner characteristics and image quality to those in Comparative Examples 8 and 9.

### Comparative Example 10

The toner obtained in Comparative Example 9 was used to evaluate image density and cockle, wherein the amount of toner to be used per unit area was doubled. The image density was 1.41, and in the evaluation of cockle, the level of the warpage at the end of the paper was 3.0 cm.

### INDUSTRIAL APPLICABILITY

As described in detail above, the toner of the present invention, in which filtrate obtained by filtering a dispersion comprising 0.2 g of the toner dispersed in 100 ml of tetrahydrofuran through a filter with a pore size of 0.45 μm, when it is measured by a spectrophotometer, has a maximum absorption between 380 nm and 440 nm wherein the absorbance at the maximum absorption is 1 or higher, or has a maximum absorption between 640 nm and 680 nm wherein the absorbance at the maximum absorption is 0.2 or higher, or has a maximum absorption between 490 nm and 560 nm wherein the absorbance at the maximum absorption is 0.15 or higher, is excellent in dispersibility of the pigment and can provide good images.

Moreover, the method for producing the toner according to the present invention provides a toner that is excellent in dispersibility of the pigment and can provide good images.

1. A toner comprising at least a pigment and a binder resin,
wherein a filtrate obtained by filtering a dispersion comprising 0.2 g of said toner dispersed in 100 ml of tetrahydrofuran through a filter with a pore size of 0.45 μm, when it is measured by a spectrophotometer, has:
a maximum absorption between 380 nm and 440 nm wherein the absorbance at the maximum absorption is 1 or higher;
a maximum absorption between 640 nm and 680 nm wherein the absorbance at the maximum absorption is 0.2 or higher; or
a maximum absorption between 490 nm and 560 nm wherein the absorbance at the maximum absorption is 0.15 or higher.

2. The toner according to claim 1, wherein said filtrate preferably has a ratio A/(A+B) of 0.1 or more for the peak detected at a wavelength of 410 nm or 540 nm by a UV detector, wherein A denotes the area of a region where the molecular weight exceeds 2,000 and B denotes the area of a region where the molecular weight is from 500 to 2,000, when measured by gel permeation chromatography.

3. The toner according to claim 1, wherein said filtrate has a basicity of 10 mmol/g or less.

4. The toner according to claim 1, further comprising a charge control resin.

5. The toner according to claim 4, wherein the charge control resin has a weight average molecular weight in the range from 2,000 to 50,000.

6. The toner according to claim 1, further comprising a parting agent.

7. The toner according to claim 6, wherein said parting agent is a multifunctional ester compound.

8. The toner according to claim 1, wherein said pigment has the following structure:
—N=N—CH(COCH₃)—CONH—
in the molecular structure thereof.

9. The toner according to claim 1, wherein said pigment is a phthalocyanine pigment.

10. The toner according to claim 1, wherein the toner has a volume average particle diameter (Dv) in the range from 3 to 10 μm, the ratio (Dv/Dp) of the volume average particle diameter (Dv) to the number average particle diameter (Dp) in the range from 1 to 1.3, and the ratio (rl/rs) of the length (rl) to the breadth (rs) in the range from 1 to 1.2.

11. The toner according to claim 1, wherein the toner has a tetrahydrofuran-insoluble content in the range from 0 to 80% by weight.

12. The toner according to claim 1, wherein the aqueous extract solution thereof has a pH in the range from 4 to 7.

13. The toner according to claim 1, wherein the number of particles of said pigment having the length of at least 0.2 μm, counted in an area of 100 μm×100 μm of the toner having a thickness of 20 μm, which is prepared by melting the toner at a temperature of 170° C., is 50 or less.

14. A method for producing a toner comprising a step of polymerizing, in an aqueous dispersion medium, a polymerizable monomer composition comprising a polymerizable monomer and a pigment, characterized in that said polymerizable monomer composition comprises an epoxy compound or an acid halide having radical polymerizability.

15. The method for producing the toner according to claim 14, wherein the content of said epoxy compound or said acid halide is in the range from 0.1 to 5 parts by weight per 100 parts by weight of said polymerizable monomer.

16. The method for producing the toner according to claim 14, wherein said polymerizable monomer composition further comprises a charge control resin.

17. The method for producing the toner according to claim 14, wherein the charge control resin has a weight average molecular weight in the range from 2,000 to 50,000.
